(19) United States
(12) Patent Application Publication
(10) Pub. No.: US 2019/0134961 A1
(43) Pub. Date: May 9, 2019

(54) GAS-BARRIER HEAT-SHRINKABLE FILM

(71) Applicant: Cryovac, Inc., Charlotte, NC (US)

(72) Inventors: Eirini Stafyla, Rho (IT); Giuliano Zanaboni, Trecate (IT); Aida Haxhi, Alessandria (IT); Francesca D'Apollo, Parabiago (IT); Lorenzo Giordano, Rho (IT); Michelangelo Bulgarelli, Rho (IT)

(21) Appl. No.: 16/305,938

(22) PCT Filed: May 31, 2017
(86) PCT No.: PCT/EP2017/063213

§ 371 Date: Nov. 30, 2018

(30) Foreign Application Priority Data
Jun. 1, 2016 (EP) 16172542.9

(51) Int. Cl. B32B 27/08; B32B 27/32; B32B 27/36; B32B 27/30; B29C 48/00; B29C 48/21; B29C 48/88; B29C 55/12; B29C 55/26; B29C 71/02; B65D 65/40; B65B 9/12; B65B 53/02; B65B 5/06

(52) U.S. Cl. CPC B32B 27/08; B29K 2101/12; B32B 27/36; B32B 27/306; B29C 48/0018; B29C 48/21; B29C 48/911; B29C 55/12; B29C 55/26; B29C 71/02; B65D 65/40; B65B 9/12; B65B 53/02; B65B 5/068; B32B 2307/7242; B32B 2553/00; B32B 2307/736; B32B 2307/31; B29C 2071/022; B32B 2307/518; B32B 27/32

(57) ABSTRACT

The present invention refers to a versatile gas-barrier multilayer heat-shrinkable thermoplastic film that, by minimal variations in its manufacturing process, becomes suitable for the manufacture of packages, called “Flowpack”, on horizontal form-fill-seal (HFFS) machines, of tray-lidded packages or of shrinkable packaging bags. This film comprises a first outer sealant layer, a second outer polyester layer, an inner barrier layer, no polyamide or polyester inner layer(s), no polyolefin layers positioned between the barrier layer and the sealant layer and at least a polyolefin bulk layer of specific relative thickness placed between the inner barrier layer and the outer polyester layer.

### FIELD OF THE INVENTION

The present invention refers to a versatile, gas-barrier multilayer heat-shrinkable thermoplastic film that, by minimal variations in its manufacturing process, becomes suitable for the manufacture of packages, called “Flowpack”, on horizontal form-fill-seal (HFFS) machines, of tray-lidded packages or of shrinkable packaging bags.

### BACKGROUND OF THE INVENTION

Multilayer thermoplastic films have been used for packaging various food and non-food products to protect them from the environment during storage and distribution.

Said films typically need to combine a number of different properties in order to be fit-for-use in the desired packaging applications.

For packaging of food products, it is often necessary that the film has oxygen barrier characteristics to delay or avoid product oxidation or degradation during its shelf-life. Also for the packaging of non-food products, it may be sometimes desirable or necessary to prevent as much as possible contact of the packaged products with conventional atmosphere and in such a case a gas-barrier film is employed. Several different materials have been used to decrease the oxygen permeability of thermoplastic films. Among these materials, EVOH (ethylene/vinyl alcohol copolymer) is a very good gas barrier material and several gas-barrier thermoplastic films comprising an EVOH layer have been described in the patent literature.

Good heat sealability is also required as it is essential, particularly for gas-barrier films used in applications where the contained product is to be kept either under vacuum or under a modified atmosphere, that the seals that close the package have adequate strength to guarantee the hermeticity of the package. For some applications, such as the so-called Flowpack applications on Flowvac (HFFS) machines or in manufacturing bags, the film should be heat-sealable to itself.

In Flowpack applications, usually a film web runs from a reel through a former, which creates a tube where the products are inserted at a suitable distance one from the other and typically gas-flushed. A sealing system then provides for a longitudinal seal to set the tube and for transverse seals at the beginning and at the end of each package.

For other applications, such as for instance tray lidding applications, the film should be sealable to the edges of the lower support, typically tray-shaped, or, in double-lidded packages, to a film, which in its turn will be sealed to the edges of the lower support. Therefore, the composition of the layer that will be employed as the sealant layer will be suitably selected depending on the composition of the tray or the film layer to which it shall be sealed.

Nowadays, another challenge in terms of sealability, in tray lidding packaging, is the use of mono-material trays, for instance mono polypropylene containers that do not contain any sealing liner (e.g. any polyethylene sealant). With those trays, the nature of the sealant layer of the lidding film is even more critical to guarantee package hermeticity. In the packaging field, hermeticity is becoming more and more an issue as the operating speed of packaging machines is constantly increased: in such a situation, the film must be sealable on mono-materials trays even at very low sealing times.

There are some film properties that need to be specifically tailored for different packaging applications, such as for instance heat-shrinkability.

Shrinkage of the film allows obtaining a tight and appealing package where the excess of packaging material or any looseness therein may disappear due to the shrinkage of the material itself.

In case of tray lidding packaging applications, the shrink of the lidding film improve the pack appearance as the film results well tensioned onto the container, in case of Flowpacks or bags it results in a tight wrapping around the product and, if present, the container.

The heat-shrinkability is imparted to the film by solid-state orientation or stretching of the film, either mono-axially or bi-axially, during film manufacture. In a typical process, the thick structure, which is extruded through either a round or a flat extrusion die, is quickly quenched, then it is heated to a suitable temperature, called the orientation temperature, which is higher than the glass transition temperature (Tg) of the resins used in the film itself but lower than the melting temperature (Tm) of at least one of said resins, and stretched in one or both of the machine longitudinal (direction called LD) and transverse (crosswise direction, called TD) directions.

In alternative, the orientation temperature may be set at a value even higher than the melting temperatures of all the resins used, if the residence time in the heating step is short enough to prevent melting.

When the thus obtained film is heated, the imparted orientation will allow the film to shrink or, if restrained, to create shrink tension.

However, when a container is present or the product is soft, the shrink properties of the solid-state oriented films must be carefully controlled, to avoid that the shrinking step might damage or even crush the container or the product. This issue has become particularly important in the last years not only because the use of containers (e.g., trays or more generally supports) containing recycled or scrap materials but also for their thickness reduction to make them more environment friendly, thus worsening their mechanical properties, in particular their resistance to deformation.

Examples of packaging applications for which it is particularly desirable to control the film shrink properties are both Flowpack and tray lidding applications, in which heat shrinkable films are used as wrapping or lidding films or for the manufacture of pouches in horizontal Flowpack (HFFS) or vertical (VFFS) packaging processes implemented on form-fill-seal machines.

In bag applications, the ideal shrinkability of the film is usually much higher and it is triggered at temperatures lower than those needed for shrinking tray-lidding films.

In the Flowpack packaging process, the product is often positioned within a container, generally a tray, which may be deformed when wrapped up in a gas-barrier film with a too high shrink force. In case of rectangular containers, this deformation mainly occurs along the longest sides, which generally are the weakest sides, of the container. Accordingly, gas-barrier films having a high free shrink with a reduced shrink force, especially along the direction that in the final package will insist on the weakest sides of the container, have been preferred.

Also in tray lidding applications, gas-barrier shrinkable films with a reduced shrink force, at least in the transverse direction, have been preferred as they provided a tight package without giving deformation of the tray or a too high stress on the seal, which would put at risk the hermeticity of the package. In tray lidding, deformation of the tray flange can also occur (i.e. flange tilted up or seriously distorted/scratched) when using a lidding material that exerts a too high shrink force onto the container. Specific films known in the packaging art as “soft shrink” films have been developed for these applications. Typically, these solid state oriented films, such as those described in EP729900, EP797507 and WO2011029950, offer relatively high free shrink combined with a relatively low maximum shrink tension.

Another common drawback shown by Flowpack and lidded packages kept for a while into the refrigerator is the so called “pack relaxation”, namely the appearance of unsightly wrinkles and pleats in the packaging film. Pack relaxation is not only undesirable for purely aesthetical reasons—the presence of wrinkles in the film of the package is not attractive per se—but also because it impairs the visual inspection of the packaged product. Especially in case of food products, it is particularly important that the customer is able to check the appearance of the packaged item and any impairment to a clear evaluation of the content (wrinkles, haze etc.) may discourage the purchase of the package. The phenomenon of pack relaxation, after storage of the package in the fridge, is mainly caused by an insufficient residual shrink tension of the packaging film but, in addition, it is worsen by certain tray conformations. In fact, in the packages current on the market, pack relaxation at low temperatures is even more recurrent because of a substantial restyling of the trays used in said packages.

In the last years, the down gauging of the containers has been associated with new designs and compositions aimed to impart higher rigidity despite the lower thickness. For example, containers with reinforcing ribs or double or particular flanges, as those described in WO2010003497 and EP2025596, were provided. For this kind of containers having unconventional flanges, which are designed to stand the shrink forces exerted by the shrinking film without giving a significant tray deformation, pack relaxation is more likely to occur.

On the other hand, film relaxation is less critical in case of products packaged in shrinkable flexible containers.

A common film defect rather problematic in packaging, especially in tray lidding, is curling. If the structure of the film is not symmetrical or it is devoid of internal symmetrically distributed stiff resins layers (e.g. polyamides, polyesters) the presence in the outer abuse layer of, for instance, polyester may cause or worsen the curling, i.e. the tendency of the edges of the film to roll up when the film is cut.

Both at manufacturing and customer level it is most desirable that the tubing or the film stay flat when cut. In bag-making and in HFFS applications when the tubing or web curls, it may become difficult to run the standard converting operations like unfolding, bag-making, slitting or printing.

Curling is also a serious issue because it may result in difficult running of the bags on the automatic machines (bags loader, HFFS machine, thermoform-shrink machine) and may increase the rejects due to wrong bags opening and/or web positioning.

The curling of the web is even a more serious issue in tray lidding applications, as if the lid minimally curls, the sealing bars of the lidding machine may not be able to seal it correctly along the tray flange, thus leaving non-sealed areas and resulting in non-hermetic packages. Other important requirements of the package, for the consumer perception, are the optical properties, namely its transparency and its gloss. The transparency allows the consumer to “see through” the package and inspect the product and additionally, a glossy package is undoubtedly more attractive. Particularly in the case of barrier shrink films, where the barrier layer is for example EVOH or PVDC, the wrinkling of the barrier layer due to the high shrink of the film causes a significant worsening of the optics, especially in terms of the haze of the film. For these reasons, it is crucial to preserve as much as possible excellent optical properties after the shrink, especially in the case of highly shrinking barrier films.

Finally, packaging films should be abuse resistant and stiff enough to be easily processed and printed. However, the addition of abuse resistant or stiff resins, such as polyamides or particularly aromatic polyesters, may result in further issues such as damages to the PVDC barrier layer during processing with worsened optics, a more difficult manufacturing process, bad interlayer adhesion and formation of wrinkles and, especially for polyamides, increasing of costs.

It conclusion, so many and different film requirements have led to a considerable multiplication of films offer in the market, with an inevitable increase of costs and complexity, in particular in terms of supplying raw materials, of production, distribution and marketing.

So far, to guarantee such an articulate offer, the producers of packaging films have manufactured tailored films starting from different precursor structures and under diverse process conditions.

It would be instead highly desirable to have few film precursors, namely to start from few or ideally a single multilayer structure that, with no or minimal structure modifications and simple variations of the process, in particular of the orientation conditions, would allow to produce films suitable for most packaging applications

Designing structures endowed with all the properties mentioned above and which, with minimal manufacturing adjustment, would also be suitable for rather different packaging applications such as HFFS, tray lidding and shrink bag applications, is however quite a challenge.

In this respect, the Applicant found out that certain known multilayer heat-shrinkable packaging films comprising a first outer sealant layer, a second outer polyester layer, an inner barrier layer, one or more polyolefin inner layer(s) and no polyamide or polyester inner layer(s), even if endowed with generally good packaging performance, may present a level of curling and/or values of residual shrink tension which, even if compatible with shrinkable bags applications, would be unacceptable for tray lidding.

In particular, WO20015107127A1, in the name of Cryovac, describes multilayer barrier heat shrinkable films useful for packaging articles as shrinkable bags, comprising a PVDC internal barrier layer and an outer polyester layer. While most films of the invention include polyamide or polyester inner layers, the films of Example 1 and Comparative Example 2 do not. In particular, the eight layers film of Ex 1 comprises two polyolefin-based layers, one adhered to the outer seal layer and the other (sixth layer) placed between the barrier and the outer polyester layer. The six layers film of the Comparative Example 2 includes only one inner polyolefin layer, directly adhered to the outer seal layer. These films, even if acceptable for bags applications, would not be suitable for tray lidding, because of the too high shrink and, after cold storage, the package relaxation.

WO2005011978A1 in the name of Cryovac describes high modulus, bi-axially oriented films for different packaging applications, comprising a first outer layer comprising a polyester or a copolyester, a second outer sealant layer, an inner barrier layer comprising an ethylene-vinyl alcohol copolymer, and no core polyamide or polyester layers. Additional inner polyolefin layers might be present, preferably positioned between the core EVOH-containing layer and the sealant layer, as exemplified in the films of Examples 28 and 29. These films may not be ideal for tray lidding, especially due to non-optimal residual shrink tension. The other films herein exemplified do not include any inner polyolefin based layer but only thin tie layers.

U.S. Pat. No. 6,406,763 in the name of Cryovac relates to multilayer heat-shrinkable films useful for packaging food products as shrinkable bags to be pasteurized after packaging. These films comprise a first outer layer comprising one or more thermoplastic materials selected among polyester, ethylene/alpha-olefin copolymer, styrene/butadiene block copolymer and ethylene/styrene random copolymer, a second outer sealant layer, one or more inner layers in which at least one includes an ethylene/α-olefin copolymer and an, optional, inner barrier layer.

If the first outer layer includes polyester, then the inner layers may contain polyamides or polyesters but in amount lower than the weight amount of polyester in the second outer layer. The only film having a polyester based first outer layer disclosed in this document is the eight-layer film of Example 1. This film is devoid of internal polyamide or polyester based layers and comprises two bulk polyolefin-based layers, one adhered to the outer seal layer and the other (sixth layer) placed between the EVOH barrier layer and the outer polyester layer.

The above documents are neither particularly concerned with curling issues or package relaxation nor provide precise explanations in relation to the positioning or the thickness of inner polyolefin layers. In this respect, U.S. Pat. No. 6,406,763 states that the inner polyolefin layers (therein “Core layers”) were introduced in the film with the aim to improve one or more of its shrink, strength, modulus, optical, permeation, and abuse-resistance and also, to facilitate extrusion and orientation in the process used to make the film.

In case of a single inner polyolefin layer, this core layer is said to be preferably adhered to the outer sealant layer. In alternative, a preferred construction includes two inner polyolefin layers disposed on either side of the internal barrier layer to form a “balanced” film construction.

U.S. Pat. No. 6,146,726 in the name of Kureha relates to a multilayer heat-shrinkable film for bag applications having improved sealing properties due to the incorporation of a peculiar ethylene-1-octene copolymer in the sealant layer.

This film comprises an outer sealant layer, an inner gas barrier layer, an outer layer comprising a thermoplastic resin, possibly a polyester, and an inner layer placed between the gas barrier layer and the outer layer, wherein said inner layer is formed of a resin selected from the group consisting of polyamide resins, polyester resins and ethylene copolymer resins.

The document neither disclose nor suggest a film devoid of inner polyamide or polyester layers, comprising an outer polyester layer, an inner layer—placed between the inner gas barrier layer and the outer polyester layer—said inner layer being made of an ethylene copolymer resin and having a percentage thickness ratio of 15 to 50% with respect to the total film thickness.

EP2805821 describes heat shrinkable packaging films and their manufacturing process. These films are characterized by peculiar shrink properties and are suitable for Flowpack or tray lidding applications.

US20090176117 is directed to thermoforming packages made of top and bottom web films and to a method of forming said packages.

Obtaining gas-barrier films—starting from simple single precursor structures—said films having high abuse resistance and stiffness, without using inner polyamide or polyester layers, very good optics even after shrink, minimal or no curling and a high residual shrink tension, and by minimal processing adjustments making said films suitable for manufacturing bags, Flowpacks as well as tray lidding packages endowed with good hermeticity and pack appearance, was still a challenge for packaging materials manufacturers.

### SUMMARY

The Applicant, starting from tubings and tapes substantially having the same peculiar layer sequence and composition and by applying conventional tailored orientation and annealing conditions, was able to obtain films suitable for very different packaging applications.

In particular, the Applicant has found out that multilayer asymmetrical gas-barrier heat-shrinkable films comprising a first outer sealant layer, a second outer polyester layer, an inner barrier layer, no polyamide or polyester inner layer(s), no polyolefin layers positioned between the barrier layer and the sealant layer, in which at least a polyolefin bulk layer of specific relative thickness is placed between the inner barrier layer and the outer polyester layer, are unexpectedly not only devoid of curling but also show high values of residual shrink tension.

These films can be thus successfully used in rather different packaging applications, such as shrinkable bags, Flowpacks and even in the most demanding tray lidding.

The film shrink properties required for the chosen application, such as free shrink and max shrink tension, can be tailored for instance on the rigidity and design of the container and on the softness of the product to be packaged, resulting in packages devoid of defects, such as tray distortion, loss of hermeticity and pack relaxation.

Advantageously, in HFFS applications, thanks to the absence of curling, the film also allows speeding up the machine cycles thus reducing packaging time and manufacturing costs.

Accordingly, in a first object, the present invention is directed to a multilayer asymmetrical heat-shrinkable gas-barrier thermoplastic packaging film comprising
an outer sealant layer (B),
an inner gas-barrier layer (A),
an outer layer (C) comprising a major proportion of polyester(s),
at least an inner layer (D), positioned between the gas barrier layer (A) and the outer layer (C), comprising a major proportion of polyolefin(s) and/or of ethylene-vinyl acetate copolymer(s),
no inner layer comprising a major proportion of polyamide(s) or polyester(s),
no inner layer positioned between the gas barrier layer (A) and the sealant layer (B) comprising a major proportion of polyolefin(s),
   wherein the thickness ratio in percentage of the inner layer (D) with respect to the total thickness of the film is from 15 to 50%, preferably from 15% to 35%.

In a second object, the present invention is directed to a process for manufacturing the film according to the first object of the present invention comprising the steps of:

a) coextruding the resins and/or blends of resins of the various layers through a round or flat extrusion die, thus obtaining a tube or sheet;
b) quenching the tube or sheet at temperature comprised between 5 and 25° C.;
c) optionally, cross-linking the tube or sheet, preferably by electron beam treatment at a radiation dosage in the range from 5 to 150 KGy;
d) heating the tube or sheet at an orientation temperature comprised between 85° C. and 160° C.;
e) simultaneously or sequentially biaxially stretching the heated tube or sheet at a stretching ratio of at least 2.5:1 and of at most 5:1 in each one of the transverse (TD) and longitudinal (LD) directions;
f) annealing the stretched tube or sheet by heating it at a temperature from 45° C. to 105° C.;
g) cooling the annealed tube or sheet at a temperature lower than 40° C.

In a third object, the present invention relates to a packaging process wherein the film of the present invention is used.

Preferably, said packaging process is a process on a horizontal form-fill-seal (HFFS) machine, which comprises:

(a) providing a film according to the first object of the present invention
(b) running the film through a former thus forming a tube
(c) inserting a product, optionally placed in a container, into the tube,
(d) sealing the tube longitudinally,
(e) sealing and cutting the tube transversally at the beginning and at the end of the package, optionally gas-flushing the tube before closing it, and
(f) heat shrinking the package.

In another embodiment, the packaging process of the present invention is directed to a tray lidding packaging process, which comprises:

(I) providing a tray with a heat-sealable rim
(II) loading said tray with the product to be packaged
(III) applying a lid on top of said tray,
(IV) heat-sealing said lid to the tray rim, optionally modifying the atmosphere between said lid and said tray, thus providing a package and
(V) heat shrinking the package, simultaneously or subsequently to the sealing step, in which the lid is a film according to the first object of the present invention.

In a fourth object, the present invention is directed to a package comprising the film of the first object. In a fifth object, the present invention is directed to the use of the film according to the first object, in a packaging process, preferably in a packaging process on a horizontal form-fill-seal machine HFFS or in a tray lidding packaging process, wherein the film is optionally used in combination with an innermost gas-permeable packaging film, or in the manufacture of shrinkable flexible containers.

### BRIEF DESCRIPTION OF DRAWINGS

FIG. 1 illustrates a possible rollers arrangement suitable for annealing the film according to the present invention.

FIG. 2 is a scheme representing the deformation of a tray and the relevant parameters taken into account in the present test method to evaluate the effect of the shrinkage of the film onto tray dimensions and shape.

FIG. 3 illustrates the test method and tool for film curling measurement as herein described.

FIGS. 4 and 5 represent two triangular wood dummies mimicking parmesan chunks used in the HFFS packaging tests with details on dummy's dimensions and positioning.

FIGS. 6A and 6B show the pictures of Flowpack packages of triangular dummies simulating parmesan chunks made with the films of the invention.

### DEFINITIONS

As used herein, the term “film” is inclusive of plastic web, regardless of whether it is a film or a sheet or a tubing.

As used herein, the term “asymmetrical film” refers to a multilayer film, which is not symmetrical in terms of number of layers and/or layer's composition and/or layer's thickness with respect to an inner reference layer. In the present context, the reference layer is the inner gas barrier layer (A). The present films are asymmetrical films at least because of the different composition of the first and second outer layers and of the asymmetrical position of the polyolefin layer(s) (D).

As used herein the phrases “inner layer” and “internal layer” refer to any film layer having both of its principal surfaces directly adhered to another layer of the film.

As used herein, the phrase “outer layer” refers to a film layer having only one of its principal surfaces directly adhered to another layer of the film.

As used herein, the phrases “seal layer”, “sealing layer”, “heat seal layer”, and “sealant layer”, refer to the film outer layer which will be involved in the sealing of the film either to itself or to another film or sheet to close the package and that will thus be in contact with, or closer to, the packaged product.

As used herein, the phrase “adhesive layer” or “tie layer” refers to any inner film layer having the primary purpose of adhering two layers to one another.

As used herein, the term “bulk layer” refers to a layer of a multilayer film, which has a thickness ratio, in percentage, with respect to the total film thickness higher than 15% or 20% or more.

As used herein, the phrases “longitudinal direction” and “machine direction”, herein abbreviated “LD” or “MD”, refer to a direction “along the length” of the film, i.e., in the direction of the film as the film is formed during coextrusion.

As used herein, the phrase “transverse direction” or “crosswise direction”, herein abbreviated “TD”, refers to a direction across the film, perpendicular to the machine or longitudinal direction.

As used herein, the term “coextrusion” refers to the process of extruding two or more materials through a single die with two or more orifices arranged so that the extrudates merge and weld together into a laminar structure before chilling, i.e., quenching. Coextrusion can be employed in film blowing, free film extrusion, and extrusion coating processes.

As used herein, the term “solid state orientation” refers to the process of stretching of the cast film generally carried out at a temperature higher than the Tg (glass transition temperatures) of all the resins making up the layers of the structure and lower than the temperature at which all the layers of the structure are in the molten state. The solid-state orientation may be mono-axial, transversal or, preferably, longitudinal, or, preferably, bi-axial.

As used herein, the phrases “orientation ratio” and “stretching ratio” refer to the multiplication product of the extent to which the plastic film material is expanded in the two directions perpendicular to one another, i.e. the machine direction and the transverse direction. Thus, if a film has been oriented to three times its original size in the longitudinal direction (3:1) and three times its original size in the transverse direction (3:1), then the overall film has an orientation ratio of 3×3 or 9:1.

As used herein the phrases “heat-shrinkable”, “heat-shrink” and the like, refer to the tendency of the solid-state oriented film to shrink upon the application of heat, i.e., to contract upon being heated, such that the size of the film decreases while the film is in an unrestrained state. As used herein said term, refer to solid-state oriented films with a free shrink in at least one of the machine and the transverse directions, as measured by standard ASTM D 2732, of at least 5%, preferably at least 10%, at 85° C. in water.

As used herein the phrases “total free shrink” means a value determined by adding the percent free shrink in the machine (longitudinal) direction to the of free shrink in the transverse (crosswise) direction.

As used herein, the term “maximum shrink tension” refers to the maximum value of tension developed by the films during the heating/shrinking process performed according to the test method described under the present experimental section.

As used herein, the term “residual shrink tension” refers to the shrink tension that the films show at the temperature of 5° C. after that the complete heating-cooling cycle of the test method has been performed as described under the present experimental section.

As used herein, the term “annealing” refers to a heat-treatment process aiming at the partial removal of strains and stresses set up in the material during its forming and fabricating operations. As used herein, the terms “major proportion” and “minor proportion” when referred to a resin as a component of a layer, refer to an amount respectively higher than 50 wt. %, preferably higher than 60 wt. %, higher than 70 wt. %, higher than 80 wt. %, higher than 90 wt. %, higher than 95 wt. %, at most 100 wt. %, or lower than 50 wt. %, preferably lower than 40 wt. %, than 30 wt. %, than 20 wt. % or than 10 wt. % of said resin calculated on the overall weight of the layer.

As used herein with the terms “polyamide layer” or “polyester layer” or “polyolefin layer” it is intended to refer to layers comprising a major proportion of polyamide(s) or of polyester(s) or of polyolefin(s) respectively.

As used herein, the (s) in brackets after a polymer name—such as for instance polyester(s), polyamide(s) or polyolefin(s)—means that one or more (i.e. also blends) of said polymer are intended. As used herein, the term “homo-polymer” is used with reference to a polymer resulting from the polymerization of a single monomer, i.e., a polymer consisting essentially of a single type of mer, i.e., repeating unit.

As used herein, the term “co-polymer” refers to polymers formed by the polymerization reaction of at least two different monomers. When used in generic terms the term “co-polymer” is also inclusive of, for example, ter-polymers. The term “co-polymer” is also inclusive of random co-polymers, block co-polymers, and graft co-polymers.

As used herein, the terms “(co)polymer” and “polymer” are inclusive of homo-polymers and co-polymers.

As used herein, the term “polyolefin” refers to polymerized olefin, which can be linear, branched, cyclic, aliphatic or aromatic. More specifically, included in the term polyolefin are homo-polymers of olefins, co-polymers of olefins and their blends. Specific examples include polyethylene (PE) homo-polymer, polypropylene (PP) homo-polymer, polybutene homo-polymer, ethylene-alpha-olefin copolymer, ethylene-propylene copolymers, propylene-alpha-olefin co-polymer and butene-alpha-olefin co-polymer.

As used herein, the phrase “heterogeneous polymer” refers to polymerization reaction products of relatively wide variation in molecular weight and relatively wide variation in composition distribution, i.e., typical polymers prepared, for example, using conventional Ziegler-Natta catalysts.

As used herein, the phrase “homogeneous polymer” refers to polymerization reaction products of relatively narrow molecular weight distribution and relatively narrow composition distribution. This term includes those homogeneous polymers prepared using metallocene, or other single-site type catalysts. As used herein, the phrase “ethylene-alpha-olefin copolymer” refers to heterogeneous and to homogeneous polymers such as linear low density polyethylene (LLDPE) with a density usually in the range of from about 0.900 g/cc to about 0.930 g/cc, linear medium density polyethylene (LMDPE) with a density usually in the range of from about 0.930 g/cc to about 0.945 g/cc, and very low and ultra low density polyethylene (VLDPE and ULDPE) with a density lower than about 0.915 g/cc, typically in the range 0.868 to 0.915 g/cc, and such as metallocene-catalyzed EXACT™ and EXCEED™ homogeneous resins obtainable from Exxon, single-site AFFINITY™ resins obtainable from Dow, and TAFMER™ homogeneous ethylene-alpha-olefin copolymer resins obtainable from Mitsui. All these materials generally include co-polymers of ethylene with one or more co-monomers selected from (C4-C10)-alpha-olefin such as butene-1, hexene-1, octene-1, etc., in which the molecules of the copolymers comprise long chains with relatively few side chain branches or cross-linked structures. As used herein, the term “propylene homo- or co-polymers” refers to propylene homopolymers or to copolymers of propylene and other olefins, preferably of propylene and ethylene, and to propylene/ethylene/butene terpolymers, which are copolymers of propylene, ethylene and 1-butene. As used herein, the term “modified polyolefin(s)” refers to modified polymer(s) prepared by co-polymerizing the homo-polymer of the olefin or co-polymer thereof with an unsaturated carboxylic acid, e.g., maleic acid, fumaric acid or the like, or a derivative thereof such as the anhydride, ester or metal salt or the like. It is also inclusive of modified polymers obtained by incorporating into the olefin homo-polymer or co-polymer, by blending or preferably by grafting, an unsaturated carboxylic acid, e.g., maleic acid, fumaric acid or the like, or a derivative thereof such as the anhydride, ester or metal salt or the like. It is also inclusive of copolymers of olefins and vinyl monomers such as vinyl alcohols or esters. Specific examples of modified polyolefins are ethylene-unsaturated ester co-polymer, ethylene-unsaturated acid co-polymer, (e.g. ethylene-ethyl acrylate co-polymer, ethylene-butyl acrylate co-polymer, ethylene-methyl acrylate co-polymer, ethylene-acrylic acid co-polymer, and ethylene-methacrylic acid co-polymer), ethylene-vinyl acetate copolymers, ionomers, polymethylpentene, etc. Modified polyolefins are also referred to as “adhesive or tie” resin(s).

As used herein the term “ionomer” refers to the products of polymerization of ethylene with an unsaturated organic acid, and optionally also with an unsaturated organic acid (C1-C4)-alkyl ester, partially neutralized with a mono- or divalent metal ion, such as lithium, sodium, potassium, calcium, magnesium and zinc. Typical unsaturated organic acids are acrylic acid and methacrylic acid, which are thermally stable and commercially available. Unsaturated organic acid (C1-C4)-alkyl esters are typically (meth)acrylate esters, e.g. methyl acrylate and isobutyl acrylate. Mixtures of more than one unsaturated organic acid comonomer and/or more than one unsaturated organic acid (C1-C4)-alkyl ester monomer can also be used in the preparation of the ionomer.

As used herein, the acronym “EVA” refers to ethylene and vinyl acetate copolymers. The vinyl acetate monomer unit can be represented by the general formula: [CH3COOCH═CH2].

As used herein, the term “gas-barrier” when referred to a layer, to a resin contained in said layer, or to an overall film structure, refers to the property of the layer, resin or structure, to limit to a certain extent the passage of gases. When referred to a layer or to an overall structure, the term “gas-barrier” is used herein to identify layers or structures characterized by an Oxygen Transmission Rate (OTR evaluated at 23° C. and 0% R.H. according to standard ASTM D-3985) of less than 100 cc/m2·day·atm, even more preferably lower than 50 cc/m2·day·atm.

As used herein the terms “EVOH layer”, “polyolefin layer”, or “propylene copolymer layer” as well as the wording “layer of EVOH”, “layer of polyolefin” or “layer of propylene copolymer” refer to layers comprising a major proportion, i.e., higher than 50 wt. %, preferably higher than 60 wt. %, higher than 70 wt. %, higher than 80 wt. %, higher than 90 wt. %, higher than 95 wt. %, at most 100 wt. %, of one or more of the corresponding resins, i.e., one or more EVOH resins, one or more polyolefins, or one or more propylene copolymers respectively, calculated on the overall weight of the layer considered.

As used herein, “EVOH” refers to ethylene/vinyl alcohol copolymer. EVOH includes saponified or hydrolysed ethylene/vinyl acetate copolymers with a degree of hydrolysis preferably at least 50%, and more preferably, at least 85%. Preferably, the EVOH comprises from about 28 to about 48 mole ethylene, more preferably from about 32 to about 44 mole % ethylene.

As used herein the term “PVDC” refers to vinylidene chloride homopolymers or copolymers. A PVDC copolymer comprises a major proportion of vinylidene chloride and a minor amount of one or more comonomers. A major proportion is defined as one of more than 50%.

As used herein the term “polyamide” refers to high molecular weight polymers having amide linkages along the molecular chain, and refers more specifically to synthetic polyamides such as nylons. Such term encompasses both homo-polyamides and co-(or ter-) polyamides. It also specifically includes aliphatic polyamides or co-polyamides, aromatic polyamides or co-polyamides, and partially aromatic polyamides or co-polyamides, modifications thereof and blends thereof. The homo-polyamides are derived from the polymerization of a single type of monomer comprising both the chemical functions, which are typical of polyamides, i.e. amino and acid groups, such monomers being typically lactams or aminoacids, or from the polycondensation of two types of polyfunctional monomers, i.e. polyamines with polybasic acids. The co-, ter-, and multi-polyamides are derived from the copolymerization of precursor monomers of at least two (three or more) different polyamides. As an example in the preparation of the co-polyamides, two different lactams may be employed, or two types of polyamines and polyacids, or a lactam on one side and a polyamine and a polyacid on the other side.

As used herein, the term “polyester” refers to homopolymers or copolymers having an ester linkage between monomer units, which may be formed, for example, by condensation polymerization reactions between a dicarboxylic acid and a glycol or by self-polymerization of a hydroxy acid or ester or a lactone.

As used herein, the term “adhered”, as applied to film layers, broadly refers to the adhesion of a first layer to a second layer either with or without an adhesive, a tie layer or any other layer there between, and the word “between”, as applied to a layer expressed as being between two other specified layers, includes both direct adherence of the subject layer to the two other layers it is between, as well as a lack of direct adherence to either or both of the two other layers the subject layer is between, i.e., one or more additional layers can be imposed between the subject layer and one or more of the layers the subject layer is between.

In contrast, as used herein, the phrase “directly adhered” is defined as adhesion of the subject layer to the object layer, without a tie layer, adhesive, or other layer there between.

As used herein, the term “package” refers to the combination of all of the various components used in the packaging of a product, i.e., all components of the packaged product other than the product within the package. The package is inclusive of, for example, a rigid support member, all films used to surround the product and/or the rigid support member, an absorbent component such as a soaker pad, and even the atmosphere within the package, together with any additional components used in the packaging of the product.

As used herein, the phrase “container” or “support members” refers to a component of a package on which a product is directly placed, i.e., immediately under the product, which the product directly contacts. Food products are typically supported on a tray-like package component, which may be thermoformed into a tray or other shape, for supporting the product. With the term container, semi-rigid or rigid, foamed and non-foamed, trays or flat sheets are generally meant.

As used herein the terms “rigid” when referred to the support members or containers are intended to refer to either flat or tray-shaped supports that are capable of supporting themselves and have a specific shape, size and—if tray-shaped—volume. Support members can be flat and have any desired shape, e.g. squared, rectangular, circular, oval, etc., or preferably, they are tray-shaped with a base or bottom portion that can have any desired shape as seen above and sidewalls extending upwardly and possibly also outwardly from the periphery of said base portion, and ending with a flange surrounding the top opening. The support members for use in the packaging process of the present invention may be monolayer or multi-layer structures, foamed, partially foamed or solid.

As used herein, the phrase “flexible container” is inclusive of end-seal bags, side-seal bags, L-seal bags, U-seal bags (also referred to as “pouches”), gusseted bags, backseamed tubings, and seamless casings.

As used herein, the term “bag” refers to a packaging container having an open top, side edges, and a bottom edge. The term “bag” encompasses lay-flat bags, pouches, casings (seamless casings and backseamed casings, including lap-sealed casings, fin-sealed casings, and butt-sealed backseamed casings having backseaming tape thereon). Various casing configurations are disclosed in U.S. Pat. No. 6,764,729 and various bag configurations, including L-seal bags, backseamed bags, and U-seal bags (also referred to as pouches), are disclosed in U.S. Pat. No. 6,790,468.

As used herein “thickness ratio in percentage” means the ratio in percentage between the thickness of a layer and the total thickness of the film. For example, for a layer X being 5 microns thick and being part of a film having total thickness of 20 microns, the ratio is calculated as follows: (5 microns/20 microns)×100, resulting in a thickness ratio in percentage of 25%.

In the present context, the terms “packaging on form-fill-seal machines” will be referred to as “Flowpack packaging” and the corresponding technique will be called “Flowpack application” or “Flowpack process”. Another term used herein with substantially the same meaning of Flowpack is Flowvac.

### DETAILED DESCRIPTION

In a first object, the present invention is directed to a multilayer asymmetrical heat-shrinkable gas-barrier thermoplastic packaging film comprising
an outer sealant layer (B),
an inner gas-barrier layer (A),
an outer layer (C) comprising a major proportion of polyester(s),
at least an inner layer (D), positioned between the gas barrier layer (A) and the outer layer (C), comprising a major proportion of polyolefin(s) and/or of ethylene-vinyl acetate copolymer(s),
no inner layer comprising a major proportion of polyamide(s) or polyester(s),
no inner layer positioned between the gas barrier layer (A) and the sealant layer (B) comprising a major proportion of polyolefin(s),
   wherein the thickness ratio in percentage of the inner layer (D) with respect to the total thickness of the film is from 15 to 50%, preferably from 15% to 35%.

The films of the present invention comprises an outer sealant layer (B), an inner gas-barrier layer (A), an outer layer (C), comprising a major proportion of polyester(s), and at least an inner layer (D), positioned between the layer (A) and the outer layer (C), comprising a major proportion of polyolefin(s) and/or of ethylene-vinyl acetate copolymer(s).

For the gas-barrier layer (A), a single EVOH or a blend of two or more EVOH resins may be used as well as a blend of one or more EVOH resins with one or more polyamides or a PVdC resin.

In a preferred embodiment, the gas barrier layer comprises a blend of one or more EVOH resins with one or more polyamides, the polyamide(s) being present in minor proportion.

In this case, suitable polyamides are those commonly indicated as nylon 6, nylon 9, nylon 10, nylon 11, nylon 66, nylon 6/66, nylon 6,9 nylon 12, nylon 6,12, nylon 6,10, partially aromatic polyamides such as MXD6 and MXD6/MDI and the like, wherein a preferred polyamide is nylon 6/12, a copolymer of caprolactam with laurolactam with a low melting temperature, such as Grilon™ CF 6S or Grilon™ CA6E manufactured and marked by the company EMS. Generally, if a high oxygen barrier is needed, the amount of polyamide, if any, blended with EVOH will not be higher than 20% by weight of the overall weight of the blend, preferably not higher than 15%, and even more preferably not higher than 10%. Preferably, the polyamide content in such a barrier layer blend is about 5%.

In a more preferred embodiment, nylon 6/12 is blended with EVOH, more preferably in amount of about 5% by weight.

In a most preferred embodiment, 5% of nylon 6/12 is blended with 95% of an EVOH resin comprising from about 28 to about 48 mole % ethylene, more preferably from about 32 to about 44 mole ethylene, most preferably 44 mole % ethylene.

The gas barrier layer (A) of the present film comprises at least 50% by weight with respect to the total weight of said layer, preferably at least 70%, more preferably at least 80% or 90%, of one or more EVOH resins.

In one embodiment, gas barrier layer (A) of the present film consists of one or more EVOH resins.

The films of the present invention may comprise a gas barrier layer (A) comprising polyvinylidene chloride (PVDC).

Preferably, the PVDC resin comprises a thermal stabilizer (i.e., HCl scavenger, e.g., epoxidized soybean oil) and a lubricating processing aid, which, for example, comprises one or more acrylates. The term PVDC includes copolymers of vinylidene chloride and at least one mono-ethylenically unsaturated monomer copolymerizable with vinylidene chloride. The mono-ethylenically unsaturated monomer may be used in a proportion of 2-40 wt. %, preferably 4-35 wt. %, of the resultant PVDC. Examples of the mono-ethylenically unsaturated monomer may include vinyl chloride, vinyl acetate, vinyl propionate, alkyl acrylates, alkyl methacrylates, acrylic acid, methacrylic acid, and acrylonitrile. The vinylidene chloride copolymer can also be a ter-polymer. It is particularly preferred to use a copolymer with vinyl chloride or (C₁-C₈)-alkyl (meth)acrylate, such as methyl acrylate, ethyl acrylate or methyl methacrylate, as the comonomers. It is also possible to use a blend of different PVDC such as for instance a blend of the copolymer of vinylidene chloride with vinyl chloride with the copolymer of vinylidene chloride with methyl acrylate. Blends of PVDC and polycaprolactone (as those described in patent EP2064056 B1, example 1 to 7) are also possible and particularly useful for respiring food products such as some cheeses.

In such a case, the multilayer heat-shrinkable film, which is object of the present invention, can exhibit an oxygen transmission rate (OTR) ranging from 120 to 450, more preferably from 180 to 450 cc/m2 day atm at 23° C. and 0% relative humidity (ASTM D-3985).

The PVDC may contain suitable additives as known in the art, i.e. stabilisers, antioxidizers, plasticizers, hydrochloric acid scavengers, etc. that may be added for processing reasons or/and to control the gas-barrier properties of the resin. Particularly preferred PVDC is IXAN PV910 supplied by Solvin and SARAN 806 by Dow.

In one embodiment, the gas barrier layer (A) comprises at least 85% of PVDC, preferably at least 90%, more preferably at least 95%. In the most preferred embodiment, the barrier layer (A) consists of PVDC.

The thickness of the barrier layer may vary, depending in part on the overall thickness of the film and on its use, from 1 to 6 microns. A preferred thickness is from 1.5 to 5 microns, more preferably from 2.0 to 4 microns.

The thickness ratio in percentage of layer (A) is from 4% to 30%, preferably from 8% to 20%, more preferably from 10% to 15% with respect to the total thickness of the film.

The film of the present invention comprises a sealant layer (B). Layers (B) may comprise one or more resins selected among polyolefins, modified polyolefins and their blends.

Preferred polyolefins for the heat-sealable layer (B) are ethylene homopolymers, ethylene co-polymers, propylene homopolymers, propylene co-polymers and blends thereof.

Preferably said polyolefins or their blends are present in the sealant (B) in major proportion, preferably in amount higher than 60%, 70%, 80%, 90% or 95% by weight with respect to layer (B) weight, even more preferably layer (B) consists of said polyolefins or their blends.

More preferred polyolefins present in major proportion are ethylene homopolymers, ethylene co-polymers and blends thereof for HFFS, shrink flexible containers and tray-lidding applications—with trays with a PE based sealant surface—and propylene homopolymers, propylene co-polymers and blends thereof for tray lidding applications with trays with a PP based sealant surface.

Ethylene homo- and co-polymers particularly suitable for the heat-sealable layer (B) are selected from the group consisting of ethylene homo-polymers (polyethylene), heterogeneous or homogeneous ethylene-alpha-olefin copolymers, preferably ethylene-(C₄-C₁₀)-olefin copolymers, ethylene-cyclic olefin copolymers, such as ethylene-norbornene copolymers, block copolymers and blends thereof in any proportion.

Preferred resins are heterogeneous materials as linear low density polyethylene (LLDPE) with a density usually in the range of from about 0.910 g/cc to about 0.930 g/cc, linear medium density polyethylene (LMDPE) with a density usually in the range of from about 0.930 g/cc to about 0.945 g/cc, and very low and ultra-low-density polyethylene (VLDPE and ULDPE) with a density lower than about 0.910 g/cc; and homogeneous polymers such as metallocene-catalyzed EXACT™ and EXCEED™ homogeneous resins obtainable from Exxon, single-site AFFINITY™ resins obtainable from Dow, and TAFMER™ homogeneous ethylene-alpha-olefin copolymer resins obtainable from Mitsui. All these materials generally include co-polymers of ethylene with one or more co-monomers selected from (C4-C10)-alpha-olefin such as butene-1, hexene-1, octene-1, etc., in which the molecules of the copolymers comprise long chains with relatively few side chain branches or cross-linked structures.

In one embodiment of the film of the present invention layer (B) comprise a major proportion of LLDPE. Particularly preferred resins for the heat-sealable layer (B) are Eltex PF6220AA by Ineos, Affinity PL 1880G, Affinity PL1845G, Affinity PL1850G by Dow and Exceed 4518PA, Exceed 2018CA, Exceed 2018HA, Exact 0210 by Exxon Mobil, Infuse 9100.05 by Dow.

Propylene polymers suitable for said heat-sealable outer layer (B) are selected from the group consisting of propylene homo-polymer and propylene co- and ter-polymers with ethylene and/or a (C₄-C₁₀)-alpha-olefin, and more preferably from the group consisting of polypropylene, propylene-ethylene co-polymers, propylene-ethylene-butene co-polymers, propylene-butene-ethylene copolymers and blends thereof in any proportion.

Particularly preferred polypropylene-based resins for the heat-sealable layer are Eltex PKS350, PKS359 and PKS607 by Ineos Polyolefins, Versify 3000 by Dow, Adsyl 5C37F by Basell and Borsoft SD233CF by Borealis.

The outer sealant layer (B) may also comprise a blend of a major proportion of one or more polyolefins of the group of ethylene homo- and copolymers and propylene homo- and co-polymers, with a minor proportion of one or more other polyolefins and/or modified polyolefins, such as polybutene homo-polymers, butene-(C₅-C₁₀)-alpha-olefin copolymers, ethylene-vinyl acetate co-polymers, ethylene-(C1-C4) alkyl acrylate or methacrylate co-polymers, such as ethylene-ethyl acrylate co-polymers, ethylene-butyl acrylate co-polymers, ethylene-methyl acrylate co-polymers, and ethylene-methyl methacrylate co-polymers, ethylene-acrylic acid co-polymers, ethylene-methacrylic acid co-polymers, ionomers, anhydride grafted ethylene-alpha-olefin copolymers, anhydride grafted ethylene-vinyl acetate copolymers, rubber modified ethylene-vinyl acetate copolymers, ethylene/propylene/diene (EPDM) copolymers, and the like.

The composition of said outer heat-sealable polyolefin layer (B) will mainly depend on the final application foreseen for the end structure. For instance when the film according to the present invention is used for Flowpack applications, where it will be sealed to itself, typically the composition of the outer layer (B) will be based on ethylene polymers as these resins generally have a lower seal initiation temperature and can be sealed more easily to themselves. On the other hand, if the film is used in tray lidding applications and the container to which it has to be sealed is of polypropylene, the outer heat-sealable layer (B) will preferably be composed of propylene polymer(s) optionally blended with ethylene polymer (s).

In case of the sealant layer (B) comprises propylene homopolymers, propylene co-polymers or blends thereof, preferably they are present in total amount lower than 65%, more preferably lower than 50%, even more preferably lower than 40% by weight with respect to layer (B) weight.

Preferably, the heat-sealant layer (B) comprises one or more antifog additives.

The term “antifog film” means a plastic film having at least one surface whose properties have been modified or adapted to have antifog characteristics—that is, the property to reduce or minimize the negative effects of moisture condensation. The antifog film may incorporate or have dispersed in effective amounts one or more antifog agents in the plastic film resin before forming the resin into a film. Antifog agents are known in the art, and fall into classes such as esters of aliphatic alcohols, polyethers, polyhydric alcohols, esters of polyhydric aliphatic alcohols, polyethoxylated aromatic alcohols, non-ionic ethoxylates, and hydrophilic fatty acid esters.

Usually, the antifog agent is previously compounded in a carrier resin obtaining a masterbatch, subsequently added to the layer (B) during the extrusion of the films according to the present invention. Preferably, an antifog agent based on fatty acid esters is used. Commercially available antifog agents suitable for the films according to the first object of the present invention are for instance Cesa Nofog PEA 0050597 by Clariant, Polybatch AF1026SC by Schulman and 103697AF by Ampacet.

Particularly suitable antifog masterbatches are AF5841LL by Tosaf and AF PPC 0699 B from PolyOne. Typically, the antifog agent is incorporated into the layer (B) in an amount from 0.5 to 10% by weight based on the total weight of the layer, preferably from 1 to 5%, even more preferably from 1 to 4% by weight even if higher percentages are possible.

The thickness ratio of the outer heat-sealable layer (B) may be at most 45% of the overall thickness of the structure, preferably at most 35% and more preferably at most 30%.

Preferably, its thickness is higher than about 8%, and more preferably higher than about 10% of the overall thickness of the film or sheet, e.g., it is typically comprised between 15% and 45%, preferably, between 30 and 40%.

The films according to the first object of the present invention comprise an outer layer (C) comprising a major proportion of polyester(s).

The term “polyester(s)” refers to homopolymers or copolymers having an ester linkage between monomer units, which may be formed, for example, by condensation polymerization reactions between a dicarboxylic acid and a glycol. The dicarboxylic acid may be linear or aliphatic, i.e., oxalic acid, malonic acid, succinic acid, glutaric acid, adipic acid, pimelic acid, suberic acid, azelaic acid, sebacic acid, and the like; or may be aromatic or alkyl substituted aromatic, e.g., various isomers of phthalic acid (i.e., ortho-phthalic acid), such as isophthalic acid (i.e., meta-phthalic acid), and terephthalic acid (i.e., para-phthalic acid), as well as naphthalic acid. Specific examples of alkyl substituted aromatic acids—herein also called aromatic polyesters—include the various isomers of dimethylphthalic acid, such as dimethylisophthalic acid, dimethylorthophthalic acid, dimethylterephthalic acid, the various isomers of diethylphthalic acid, such as diethylisophthalic acid, diethylorthophthalic acid, the various isomers of dimethylnaphthalic acid, such as 2,6-dimethylnaphthalic acid and 2,5-dimethylnaphthalic acid, and the various isomers of diethylnaphthalic acid. The dicarboxylic acid can alternatively be 2,5-furandicarboxylic acid (FDCA). The glycols may be straight-chained or branched. Specific examples include ethylene glycol, propylene glycol, trimethylene glycol, 1,4-butane diol, neopentyl glycol and the like. The glycols include modified glycols such as 1,4 cyclohexane dimethanol.

Suitable polyesters include poly(ethylene 2,6-naphtalate), poly (butylene terephthalate), poly(ethylene terephthalate), and copolyesters obtained by reacting one or more, preferably aromatic, dicarboxylic acids with one or more dihydroxy alcohols, such as PETG which is an amorphous co-polyesters of terephthalic acid with ethylene glycol and 1,4-cyclohexanedimethanol.

Preferably, aromatic polyesters are used.

Particularly preferred polyesters are PETs supplied by Artenius or Ramapet by Indorama or Eastman polyester resins.

The polyester-containing layer(s) can comprise any of the above polyester either alone or in blend. In one preferred embodiment, the polyester layer consists of a single polyester resin, particularly preferred are PETs Ramapet N180 and Ramapet N1 by Indorama, Artenius PET Global by Artenius, GN001 by Eastman Chemical.

In HFFS packaging of triangular shaped products, the Applicant observed that films of the present invention comprising certain amount of PETg in the outer layer (C) performed better, remaining perfectly clear in the final shrunk package even around the exceeding sealed material.

Accordingly in another preferred embodiment, the outer polyester layer (C) comprises, more preferably consists of, a polyester's blend comprising one or more PETG(s) in amount from 30% to 50%, preferably from 35% to 45% by weight with respect to the polyester blend weight.

Preferably, the percentage by weight of the polyester(s) into the whole film is in the range of from 5 to 25%, more preferably from 8 to 20%, even more preferably from 10 to 15%.

Preferably the percentage by weight of the polyester(s) in the outer polyester containing layer is higher than 50%, 60%, 70%, 90%, 95%, more preferably higher than 98%, most preferably it substantially consists of polyester(s).

The thickness ratio in percentage of layer (C) with respect to the total film thickness is generally from 3% to 25%, preferably from 5% to 20%, from 7% to 15% or from 8% to 12%.

The polyester-comprising layer(s) may have a typical thickness of at least 1.0, at least 1.5, at least 2.0 microns.

The polyester-comprising layer(s) may have a typical thickness from 1.0 to 10 microns, preferably from 1.5 to 8 microns, more preferably from 2 to 5 microns.

The films of the present invention do not include inner layers comprising a major proportion of polyesters. Preferably, the films of the invention do not include any inner layer comprising polyester(s). Preferably, the films of the invention do not include any inner layer consisting of polyester(s).

The film according to the first object of the present invention further comprises at least one inner layer (D), positioned between the gas barrier layer (A) and the outer layer (C), comprising a major proportion of polyolefin(s) and/or of ethylene-vinyl acetate copolymer(s).

The thickness ratio in percentage of said inner layer (D) is from 15 to 50%, preferably from 15% to 35% or preferably from 20% to 30% based on the total thickness of the film.

The Applicant found out that films having propylene based sealant layers generally require higher layer (D)'s thickness ratios to be balanced, such as ratios higher than 20%, 25%, 30% or 40%.

The thickness of layer D may be in the range of from 2 to 20 microns, more preferably from 3 to 15 microns, even more preferably from 4 to 10 microns.

The layer (D) comprises a major proportion of polyolefin(s) as previously defined and/or of ethylene-vinyl acetate copolymer(s), preferably comprises at least 60%, 70%, 80%, 90% or 95% by weight with respect to layer (D) weight even more preferably consists of polyolefin(s) and/or of ethylene-vinyl acetate copolymer(s).

Preferred resins for the layer D are ethylene homopolymers, such as medium-density polyethylene MDPE and high-density polyethylene HDPE, ethylene-alpha-olefin copolymers, particularly those with a density of from about 0.895 to about 0.935 g/cc, and more preferably of from about 0.900 to about 0.930 g/cc, ethylene-vinyl acetate copolymers, particularly those with a vinyl acetate content of from about 4 to about 14% by weight, polypropylene homopolymers, propylene-ethylene co-polymers, propylene-ethylene-butene copolymers, propylene-butene-ethylene copolymers and their blends. Particularly preferred resins, for layer D, are Dowlex 2045S and 5057GC by Dow and Nucrel 1202 by DuPont.

In one preferred embodiment of the film of the present invention, layer (D) comprises a major proportion of a LLDPE, more preferably layer (D) consists of a LLDPE.

In an embodiment, layer D may comprise a minor proportion of a modified polyolefin other than ethylene vinylacetate copolymers to increase the adhesion with the adjacent layers, being either the outer layer C or an adhesive layer E. The amount of the modified polyolefin in such layer D preferably is lower than 40%, 30%, 20%, or 10% by weight with respect to layer (D) weight.

In one embodiment, layer D may comprises a minor proportion of one or more ethylene-unsaturated ester co-polymer, ethylene-unsaturated acid co-polymer, (e.g. ethylene-ethyl acrylate co-polymer, ethylene-butyl acrylate co-polymer, ethylene-methyl acrylate co-polymer, ethylene-acrylic acid co-polymer, and ethylene-methacrylic acid co-polymer). Particularly preferred commercially available modified polyolefins are ADMER AT2146E, Admer NF518E, Admer NF911E or ADMER AT2146E by Mitsui, Bynel 4104, Bynel 3861 by Dupont and Plexar PX3227 by Equistar.

In a preferred embodiment however, layer D does not comprise any modified polyolefin.

The film of the present invention may comprise more than one inner layer (D).

In case of two or more layers (D), they are directly adhered to each other and positioned between the gas barrier layer (A) and the outer layer (C).

Each one of said layers (D) comprises a major proportion of polyolefin(s) as previously defined and/or of ethylene-vinyl acetate copolymer(s).

In case the present film includes two or more layers (D), they may have the same or a different composition.

In case the present film includes two or more layers (D), the total thickness of said layers (D) with respect to the total thickness of the film in percentage is from 15 to 50%, preferably from 15% to 35% or preferably from 20% to 30%.

Preferably, layer (D) is not directly adhered to layer (C) but it can be adhered to layer (C) by interposition of an adhesive or tie layer E.

The films of the present invention preferably comprise one or more tie or adhesive layers E.

Tie layers have the primary purpose of improving the adherence of two layers to each other. Tie layers may include polymers having grafted polar groups so that the polymer is capable of covalently bonding to polar polymers such as EVOH. Useful polymers for tie layers include ethylene/unsaturated acid copolymer, ethylene/unsaturated ester copolymer, anhydride-modified polyolefin, polyurethane, and mixtures thereof. Preferred polymers for tie layers include one or more of ethylene/vinyl acetate copolymer having a vinyl acetate content of at least 15 weight %, ethylene/methylacrylate copolymer having a methyl acrylate content of at least 20 weight %, anhydride modified ethylene/methyl acrylate copolymer having a methyl acrylate content of at least 20%, and anhydride-modified ethylene/alpha-olefin copolymer, such as an anhydride grafted LLDPE. Modified polymers or anhydride-modified polymers include polymers prepared by copolymerizing an unsaturated carboxylic acid (e.g., maleic acid, fumaric acid), or a derivative such as the anhydride, ester, or metal salt of the unsaturated carboxylic acid with—or otherwise incorporating the same into an olefin homopolymer or copolymer. Thus, anhydride-modified polymers have an anhydride functionality achieved by grafting or copolymerization.

These adhesive layers may have the same or a different composition and will comprise one or more modified polyolefins as indicated above possibly blended with one or more polyolefins.

Also the thickness of the adhesive layers may vary depending on the overall film thickness and on the type of resin employed. In general, however suitable adhesive layers typically have a thickness of from 1 to 4 microns, e.g., 2-3 microns. Additional adhesive layers may be present depending on the specific structure of the film.

Generally, tie layers have a thickness ratio in percentage lower than 15%, 10%, 7% or 5% with respect to the total film thickness

Particularly preferred commercially available tie resins for the films of the present invention are ADMER AT2146E, Admer NF518E, Admer NF911E or ADMER AT2146E by Mitsui, Bynel 4104, Bynel 3861 by DuPont and Plexar PX3227 by Equistar.

Other layers (F) may be present in the overall structure, such as additional inner layers or easy-opening layers or seal assisting layers directly adhering to the heat-sealable layer (B) should this be necessary to provide the film with the desired easy-opening properties. Layer(s) (F) do not comprise polyamide(s) or polyester(s).

The films of the present invention do not comprise any layer comprising a major proportion of polyamide(s) or polyester(s).

Preferably, the films of the present invention do not comprise any layer consisting of polyamide(s) or polyester(s).

Notwithstanding the absence of inner layers made of stiff resins such as polyamides and polyesters, the present films show very good mechanical properties, even at thicknesses as low as 30 microns, 25 microns or even lower.

The films of the present invention do not include any inner bulk layer comprising a major proportion of polyolefin(s) and/or of ethylene-vinyl acetate copolymer(s), positioned between the gas barrier layer (A) and the sealant layer (B).

Preferably, the films of the present invention do not include any inner bulk layer comprising even minor proportions of polyolefin(s) and/or of ethylene-vinyl acetate copolymer(s) positioned between the gas barrier layer (A) and the sealant layer (B).

In one embodiment, the present films do not include any layer comprising polyolefins and/or EVA positioned between the gas barrier layer (A) and the sealant layer (B).

The overall thickness of the film can vary depending on the end use thereof.

Typically, the total thickness is from about 7 to about 80 microns.

In Flowpack or tray lidding applications, the total thickness is preferably lower than 40, 35, 30 or 25 microns. In Flowpack or tray lidding applications the total thickness is preferably from 10 to 40 microns, and preferably from about 10 to about 35 microns, generally of about 15, 20, 22, 24, 26, 28, 30 microns, most preferably a total thickness of from about 20 to 25 microns.

The present films advantageously show very good mechanics even at lower thickness.

In shrink bag applications, the total thickness of the film is preferably lower than 80, 70, 60, 50 or 40 microns.

In shrink bag applications, the total thickness of the film is preferably from 30 to 80 microns, from 40 to 70 microns, from 50 to 60 microns.

The film according to the present invention can comprise from 2 to 20 layers, preferably from 3 to 12 layers and more preferably, from 4 to 9 layers, even more preferably 7 layers.

In the most preferred embodiments, the film according to the present invention is a 5 or 7 layers structure.

Non-limiting examples of possible layer sequences of the film of the present invention are the following: B/A/D/C, B/A/D/E/C, B/E/A/D/C, B/E/A/D/E/C, B/E/A/E/D/E/C, B/F/A/D/C, B/F/A/D/E/C, B/F/E/A/D/C, B/F/E/A/D/E/C, B/F/E/A/E/D/E/C,

wherein, in case of repetition of the same letter in one sequence, the compositions of the relative layers can be the same or different.

In the most preferred embodiment, the film of the present invention has the sequence B/E/A/E/D/E/C. In the preferred embodiment (Emb.1) the film of the present invention has the sequence B/E/A/E/D/E/C where the same tie resin is used for all layers (E).

In an embodiment (Emb.2), the film of the present invention has the sequence B/E/A/E/D/E/C where the same adhesive resin is used for all layers (E) and layer B comprises an antifog additive.

In a preferred embodiment (Emb.3), the film of the present invention has the sequence B/E/A/E/D/E/C where the same tie resin is used for all layers (E), layer B comprises an antifog additive, the total thickness of the film is comprised between 20 and 25 microns and/or the barrier layer comprises a blend of a polyamide and EVOH.

In a more preferred embodiment (Emb.4), the film of the present invention has the sequence B/E/A/E/D/E/C where the same tie resin is used for all layers (E), layer B comprises an antifog additive, the total thickness of the film is between 20 and 25 microns and the barrier layer comprises a blend of nylon 6/12 and EVOH.

In a more preferred embodiment (Emb.5), the film of the present invention has the sequence B/E/A/E/D/E/C where the same tie resin is used for all layers E, layer B comprises an antifog additive, the total thickness of the film is comprised between 20 and 25 microns and the barrier layer comprises a blend of nylon 6/12 and of an EVOH resin comprising from about 28 to about 48 mole % ethylene, more preferably from about 32 to about 44 mole % ethylene, most preferably 44 mole % ethylene.

In still another preferred embodiment (Emb.6), the film of the present invention has the sequence B/E/A/E/D/E/C where the same tie resin is used for all layers E, layer B comprises an antifog additive, the total thickness of the film is comprised between 20 and 25 microns and the barrier layer comprises a blend of nylon 6/12 and of an EVOH resin comprising from about 28 to about 48 mole % ethylene, more preferably from about 32 to about 44 mole % ethylene, most preferably 44 mole % ethylene and the thickness of the barrier layer A is comprised between 1 and 6 microns, preferably 1.5 and 5 microns, and more preferably between 2.0 and 4 microns.

In a still preferred embodiment (Emb.7), the film of the present invention has the sequence B/E/A/E/D/E/C where the same tie resin is used for all layers E, layer B comprises an antifog additive, the total thickness of the film is comprised between 20 and 25 microns and the barrier layer consists of a blend of 5% nylon 6/12 and 95% of an EVOH resin comprising from about 28 to about 48 mole % ethylene, more preferably from about 32 to about 44 mole % ethylene, most preferably 44 mole % ethylene and the thickness of the barrier layer is comprised between 1 and 6 microns, preferably between 1.5 and 5 microns, and more preferably between 2.0 and 4 microns.

In the most preferred embodiment (Emb.8), the film of the present invention has the sequence B/E/A/E/D/E/C where the same tie resin is used for all layers (E), layer (B) comprises a major proportion of LLDPE and comprise an antifog additive, the total thickness of the film is comprised between 20 and 25 microns, the barrier layer consist of a blend of 5% nylon 6/12 and 95% EVOH resin comprising from about 28 to about 48 mole % ethylene, more preferably from about 32 to about 44 mole % ethylene, most preferably 44 mole % ethylene, the thickness of the barrier layer is comprised between 1 and 6 microns, preferably between 1.5 and 5 microns, and more preferably between 2.0 and 4 microns.

In a preferred embodiment (Emb.9), layer C, according to anyone of embodiments Emb.1 to Emb.8, comprises or consists of polyethylene terephthalate (PET).

In an embodiment (Emb.10), layer C, according to anyone of embodiments Emb.1 to Emb.9, comprises or consists of polyethylene terephthalate (PET) and has a thickness of from 1.5 to 5 microns.

In a preferred embodiment (Emb.11) layer (D) according to anyone of embodiments 1 to 10, consists of one or more polymers selected among ethylene homopolymers, preferably linear low-density polyethylenes, polypropylene homopolymers and propylene-ethylene co-polymers.

In a preferred embodiment (Emb.12) layer (D) according to anyone of embodiments 1 to 11 has a thickness ratio in percentage from 20% to 30%.

In a preferred embodiment (Emb.13) according to anyone of embodiment 1 to 12, the film of the present invention has a thickness lower than 50 microns, preferably lower than 30 microns.

One or more of the layers of the film of the present invention may contain any of the additives conventionally employed in the manufacture of polymeric films. Thus, agents such as pigments, lubricants, anti-oxidants, radical scavengers, oxygen scavengers, UV absorbers, odour absorbers, antimicrobial agents, thermal stabilizers, anti-blocking agents, surface-active agents, slip aids, optical brighteners, gloss improvers, viscosity modifiers may be incorporated as appropriate. In particular, to improve the processing of the film in high-speed packaging equipment slip and/or anti-blocking agents may be added to one or both of the outer layers. The additives may be added in the form of a concentrate, preferably in a polyethylene carrier resin. More preferably, the same masterbatch incorporates both the antiblock and the antifog agents. As an alternative, slip agents may be added by coating, for instance by plasma coating or by spraying. The amount of additive is typically in the order of 0.2 to 5% by weight of the total weight of the layer.

The films of the present invention are preferably coextruded, as hereinafter described.

The films of the present invention are preferably cross-linked, as hereinafter described.

Finally, the films of the present invention can be printed by using techniques well known in the art.

The films according to the present invention show very good optical properties, particularly an haze value between 1% and 15% measured according to standard ASTM D 1003, preferably an haze not higher than 10%, more preferably a haze not higher than 8% and even more preferably not higher than 5% and a gloss value (60° angle) higher than 100, 110, or 120 g.u., preferably between 100 g.u. e 150 g.u., more preferably between 110-140 g.u measured according to standard ASTM D 2457.

The films according to the present invention suitable for Flowpack packaging are further characterized by:
a maximum shrink tension, measured according to the test method herein reported, lower than 45 kg/cm² both in the longitudinal and transverse directions and/or higher than 15 kg/cm² both in the longitudinal and transverse directions; and/or
a residual shrink tension at 5° C., measured according to the test method herein reported, lower than 45 Kg/cm² both in the longitudinal and transverse directions and/or higher than 25 Kg/cm², preferably of 26 Kg/cm² both in the longitudinal and transverse directions; and/or
a free shrink in the longitudinal direction, measured at 85° C. in water according to ASTM D 2732, higher than 5%, preferably higher than 10%, even more preferably higher than 15%, and/or preferably lower than 30% or 25% or 20%; and/or
a free shrink in the transverse direction, measured at 85° C. in water according to ASTM D 2732, higher than 5%, preferably higher than 10% and/or preferably lower than 30% or 25% or 20%; and/or
a difference between the free shrink values in the longitudinal direction and transverse directions, measured at 85° C. in water according to ASTM D 2732, lower than 15%, preferably than 10%, even more preferably lower than 5%; and/or
an elastic modulus, measured according to ASTM D 882, in the range 8000 to 14000 kg/cm², preferably between 9000 and 12000 kg/cm² in each of the longitudinal and transverse directions; and/or
an elongation at break, measured according to ASTM D 882, in the range 70 to 140%, preferably between 80 and 110% in each of the longitudinal and transverse directions; and/or
a tensile at break, measured according to ASTM D 882, in the range 700 to 1200 kg/cm², preferably between 800 and 1100 kg/cm² in each of the longitudinal and transverse directions; and/or
a curling, measured according to the test method herein reported, not higher than 20%, preferably not higher than 15% in each one of the longitudinal and transverse directions and/or not higher than 10%, than 5% or than 1% in the transverse direction. More preferably, the curling in transverse direction is about 0%.

The films according to the present invention suitable for tray lidding packaging are further characterized by
a maximum shrink tension, measured according to the test method herein reported, lower than 25 kg/cm² both in the longitudinal and transverse directions and/or higher than 7 kg/cm² both in the longitudinal and transverse directions; and/or
a residual shrink tension at 5° C., measured according to the test method herein reported, lower than 36 Kg/cm² both in the longitudinal and transverse directions and/or higher than 25 Kg/cm², preferably than 26 Kg/cm², more preferably than 27 Kg/cm², or than 28 Kg/cm² both in the longitudinal and transverse directions; and/or
a free shrink in the longitudinal direction, measured at 85° C. in water according to ASTM D 2732, higher than 5%, and/or preferably lower than 15%; and/or
a free shrink in the transverse direction, measured at 85° C. in water according to ASTM D 2732, higher than 3%, and/or preferably lower than 10%; and/or
a difference between the free shrink values in the longitudinal direction and transverse directions, measured at 85° C. in water according to ASTM D 2732, lower than than 10%, even more preferably lower than 5%; and/or
an elastic modulus, measured according to ASTM D 882, in the range 8000 to 14000 kg/cm², preferably between 9000 and 12000 kg/cm² in each of the longitudinal and transverse directions; and/or
an elongation at break, measured according to ASTM D 882, in the range 70 to 160%, preferably between 80 and 130% in each of the longitudinal and transverse directions; and/or
a tensile at break, measured according to ASTM D 882, in the range 700 to 1200 kg/cm², preferably between 800 and 1100 kg/cm² in each of the longitudinal and transverse directions; and/or
a curling, measured according to the test method herein reported, not higher than 10%, in each one of the longitudinal and transverse directions and/or not higher than 5%, preferably not higher than 1% in the transverse direction. Most preferably, the curling in transverse direction is about 0%.

In a second object, the present invention is directed to a process for manufacturing the films according to the first object of the present invention comprising the steps of:

a) coextruding the resins and/or blends of resins of the various layers through a round or flat extrusion die, thus obtaining a tube or sheet;
b) quenching the tube or sheet at temperature comprised between 5 and 25° C.;
c) optionally, cross-linking the tube or sheet, preferably by electron beam treatment at a radiation dosage in the range from 5 to 150 KGy;
d) heating the tube or sheet at an orientation temperature comprised between 85° C. and 160° C.;
e) simultaneously or sequentially biaxially stretching the heated tube or sheet at a stretching ratio of at least 2.5:1 and of at most 5:1 in each one of the transverse (TD) and longitudinal (LD) directions;
f) annealing the stretched tube or sheet by heating it at a temperature from 45° C. to 105° C.;
g) cooling the annealed tube or sheet at a temperature lower than 40° C.

The films according to the present invention can be obtained by coextrusion of the resins and/or blends of resins of the various layers through a round or flat extrusion die (step a), quickly followed by quenching (step b).

Preferably, a round die is used and the distance between the die exit and the forming shoe has to be kept between 5 and 15 cm, preferably between 8 and 10 cm. At the forming shoe, the tube is quenched by water and/or air treatment, at temperature lower than 25° C., preferably lower than 20° C., more preferably at temperatures lower than 15° C.

Preferably, the quenching temperature is comprised between 5 and 25° C., more preferably between 8° C. and 20° C.

The thick tube or sheet is then preferably cross-linked (step c) to improve the strength of the film, the orientability of the film, and to help avoiding burning through or sticking on the sealing bars during heat seal operations at packaging machine. Cross-linking may be achieved by using chemical additives or, preferably, by subjecting the film layers to one or more energetic radiation treatments such as ultraviolet, X-ray, gamma ray, beta ray, and high energy electron beam treatment to induce cross-linking between molecules of the irradiated material. The film may be exposed to radiation dosages of at least 5, preferably at least 7, more preferably at least 10, most preferably at least 15 kGy (kilo Grays). The radiation dosage may also range from 5 to 150, preferably from 10 to 100, more preferably from 15 to 75 kGy and even more preferably 20 to 65 KGy.

Afterwards, the thick tube or sheet is heated to the orientation temperature (step d) generally comprised between 85° C. and 160° C. Depending on the packaging application, the orientation temperature is preferably comprised between 80° C. and 115° C., for shrinkable flexible containers and HHFS applications and between 110° and 125° C. for tray lidding applications.

The tube or the sheet is heated by passing it through a hot air tunnel, where the tube is further heated by contact with internally heated hot rolls, or through an IR oven and then stretched mono- or bi-axially (step e). When a round extrusion die is employed, biaxial stretching is generally carried out by the trapped bubble technique. In this technique, the inner pressure of a gas such as air is used to expand the diameter of the thick tubing obtained from the extrusion to give a larger bubble transversely stretched, and the differential speed of the nip rolls that hold the bubble is used to get the longitudinal stretching. The stretching ratio is of at least 2.5:1 in each one of TD and LD direction, preferably of at least 3.5. Preferably, the stretching ratio is of at most 5:1 in each one of TD and LD direction, preferably at most 4:1 in each one of TD and LD direction.

Preferably, the stretching ratio is comprised between 2.5 and 2.5 or comprised between 3.5 and 3.9 in each one of TD and LD directions.

Preferably, the same stretching ratio is applied in the machine and transverse direction. In some cases, it could be advantageous to apply different stretching ratio, in order to obtain quite unbalanced shrink properties in the two directions of the films.

Alternatively, when a flat die is used in the extrusion step, biaxial orientation is carried out sequentially or, preferably, simultaneously by means of a simultaneous tenter-frame.

The film so obtained can then be subjected to a heat treatment under strictly controlled conditions (annealing) (step f). In particular, such heat treatment involves heating the film to a temperature comprised between 40° C. and 105° C., preferably comprised between 60 and 100° C., depending on the desired packaging application and then cooling it down to room temperature or below.

Preferably, the annealing temperature is at most 80° C., more preferably of about 75° C. or lower for HFFS applications, from about 40° C. to 70° C. for shrinkable bags while for tray lidding films is higher than 80° C., preferably is about 90° C.

The heat treatment according to the present invention might be carried out off-line but, preferably, it is performed right on the line of all other processing operations.

Any annealing technique known in the art may be employed suitably choosing the temperature in the above range and setting the annealing time, generally ranging from 0.5 to 3 sec, also taking into account the speed of the line, to meet the above objective.

Preferably the annealing step is performed by allowing a reduction in the film width from 5% to 35%, preferably from 6% to 25%, but manufacturing processes in which the annealing step does not change film's width—by suitably clamping the film—are also included in the present invention.

Preferably, in case of films for Flowpack applications the annealing step is performed by allowing a reduction in the film width from 7 to 10% while for tray lidding applications from 20 to 30%.

In particular, such a heat treatment may be part of the overall process or be a step added thereto.

In the former case, the annealing may be obtained, for instance, by using the “triple bubble” technology. In the triple bubble technology first a bubble is extruded downward into a water quench, then the tube is reheated and inflated in an orienting station (“second bubble”) and finally it goes to an annealing station (“third bubble”).

In the latter case, before being wound up, the film obtained from the solid-state orientation step, either as a flattened tubular film or as a mono-ply film, is conveyed to a conventional annealing station or heated to the suitably selected temperature.

For the purpose of the present invention, the heat treatment temperature (i.e. annealing temperature) is intended to be the temperature of the heated elements with which the film is contacted to or the temperature of the environment to which the film is exposed to during said heat treatment.

In practice the film may be heated to the suitably selected annealing temperature by conventional techniques, such as, by exposure of the film to radiant elements, by passage of the film through a heated air oven or an IR oven, or by contact of the film with the surface of one or more heated plates or rollers.

According to a preferred embodiment, the heat treatment may be carried out by first running the film over and in contact with the surface of a number, e.g., 2 to 8, preferably 4 or 6, of revolving rollers heated at the suitably selected temperature, and then over and in contact with the surface of few other, e.g., 7 to 8, rollers—named chill rolls—cooled to a temperature below room temperature or in any case below 40° C.

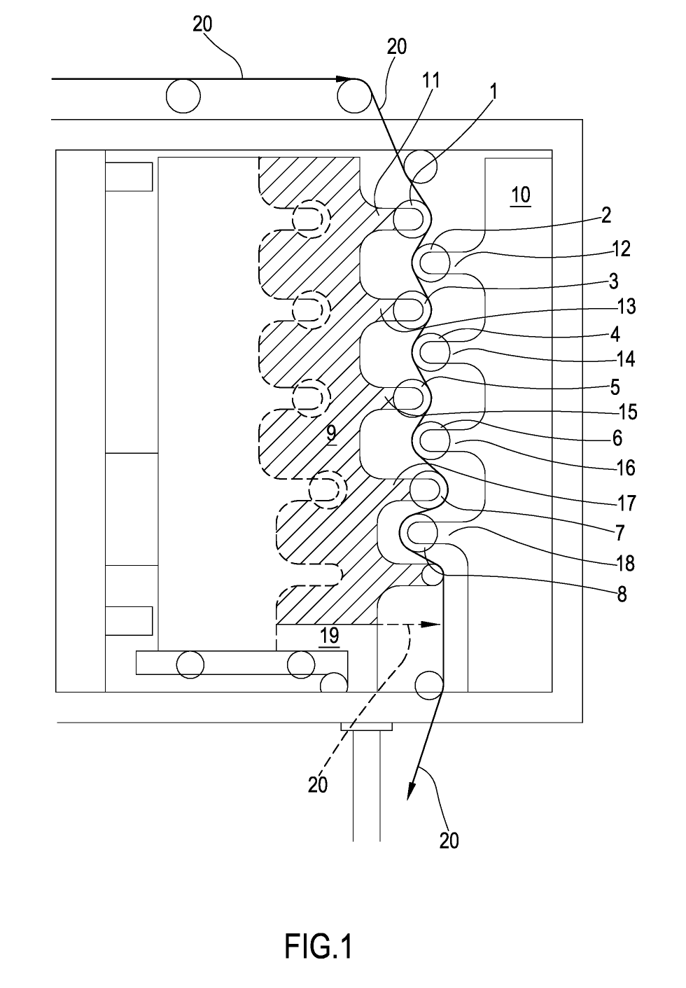

The rollers are typically disposed—as illustrated in FIG. 1—on two vertical rows, whereas rollers (1), (3), (5), and (7) are mounted on a support member (9) by means of supporting bars (11), (13), (15) and (17) and rollers (2), (4), (6), and (8) are mounted on a similar support member (10) by means of supporting bars (12), (14), (16) and (18). While support (10) is fixed, support member (9), and rollers (1), (3), (5), and (7) jointly thereto, can be moved along the axis (19) to approach support member (9). On each support member the distance between two subsequent rollers is larger than the rollers' diameter and the rollers mounted on one support member are shifted with respect to those mounted on the other support member so that by reducing the distance between the two support members the row of rollers (1), (3), (5), and (7) can come closer, align, or even go beyond that of rollers (2), (4), (6), and (8).

The film (20) is driven through this unit at a speed which generally corresponds to the speed of the production line.

Preferably, in case of films for Flowpack applications the speed of the roller is from 66 to 70 m/min while for tray lidding applications is from 60 to 64 m/min.

The contact time of the film with the heating and cooling rollers, and therefore the length of the heating time and that of the cooling time will depend on the rollers diameters, on the speed of the line, and on the distance between the two rows of rollers. In fact, for a given line speed and roller diameter, the closer the two rows the longer is the contact time. The dimensions of the rollers can be widely varied in diameter while their length is determined by the width of the film, which has to be subjected to the heat-treatment. Typically, to avoid heat dispersion on the rollers' sides and therefore an unsuccessful heat-treatment on the film edges, the roller length will be larger than the film width. The rollers' diameter typically ranges from 10 to 100 cm, and generally it is comprised between 10 and 40 cm. The rollers are typically made of stainless steel, but any material which is highly heat conductive and heat-resistant and which the thermoplastic material does not stick to, might be employed. The heating or cooling system may be provided e.g. by the use of internal spirals where a heated or cooled medium is circulated. The heating temperature is typically comprised between 50 and 105° C., preferably comprised between 60 and 100° C., depending on the intended final packaging application of the film. The period for which the film is maintained at the heating treatment temperature should not exceed 7.5 s, as an extended period at the heat treatment temperature would in fact be detrimental to the film characteristics, unacceptably decreasing the free shrink of the film. The minimum period of heat treatment of the film, in order to achieve the desired results can be as low as 0.5 s, depending on the film thickness, specific composition and shrink properties of the starting film. Typically, a period of time of at least 1 s and not more than 5, preferably not more than 4 s, is employed.

A cooling step (step g) immediately follows the heat treatment and it is carried out as quickly as possible. Generally, the temperature of the film needs to be brought to a value lower than 40° C., preferably lower than 20° C. in less than 2 s, preferably in less than 1 s. While the temperature of the cooling rollers could be as low as possible, using appropriate fluids with a freezing point below 0° C., it is generally preferred, in order to avoid condensation on the roller, cooling the rollers to a temperature of between 1 and 35° C. preferably between 10 and 40° C., more preferably between 10 and 20° C. During the above heat treatment, the film generally does not need to be constrained against shrinkage. Using in fact the preferred system for carrying out the heat treatment wherein the film web is almost tensioned by the process itself on its passing through the system of rollers at a relatively high speed, a tolerable reduction in the film width occurs of no more than 40%. Preferably, for the films of the present invention, this reduction is comprised between 5 and 35%.

This reduction can be calculated depending on the temperature of the heat-treatment and the speed of the line and taken into account at the extrusion and orientation of the starting film so that a film having the required width and thickness is obtained after the heat-treatment.

Sometimes, and mainly when the heat treatment is carried out by passing the film through a heated oven, it is also possible to avoid film shrinkage during the treatment by maintaining the film at substantially constant linear dimensions e.g., by a series of moving pinches holding the film edges, or by using a frame of the suitable dimensions.

The annealed films obtained by any of the above described processes may then be subjected to conventional after treatments—for example exposure to a corona discharge treatment to improve the bonding and print-receptive characteristics of the film surface.

In a third object, the present invention is directed to a packaging process, preferably to a Flowpack or to a tray lidding packaging process respectively wherein the packaging film according to the first object of the present invention is used.

In a preferred embodiment of the third object, the present invention is directed to a Flowpack packaging process on a HFFS machine, which comprises:
(a) providing a film according to the present invention
(b) running the film through a former thus forming a tube
(c) inserting a product, optionally placed in a container, into the tube,
(d) sealing the tube longitudinally,
(e) sealing and cutting the tube transversally at the beginning and at the end of the package, optionally gas-flushing the tube before closing it, and
(f) heat shrinking the package.

As an example a typical application of the heat-shrinkable films of the present invention is in the modified atmosphere packaging (MAP) of products preferably placed in a container e.g. a tray or on a flexible support member.

In one of these MAP packaging systems, namely the MAP Flowpack, the product in the tray is wrapped into a film envelope made around the product, typically under a suitable and predetermined atmosphere. To create the envelope the flat film is first folded around a former and longitudinally sealed to form a tube. The tray with the product is placed in such a tube where the leading edge has been closed and gas flushed with the suitably selected gas or gas mixture. The excess gas is typically removed by a gentle pressure on top of the package and the open end of the envelope is then sealed and the package separated from the tubing. The loose package is then passed into a shrink tunnel, typically a hot air one set at a temperature suitable for shrinking such as a temperature of 100-150° C., to get shrinkage of the film and thus a tight package.

Under these conditions, it is very important that the packaging film has a controlled shrink force at least in the transverse direction, as a too high shrink force will lead to a more-or-less severe distortion of the tray that in any case would impair the appearance of the end package. Such a suitable shrink force is required in at least the transverse direction because it is particularly in the transverse direction that the excess material is limited and controlled by the size of the former, while in the longitudinal direction the two transverse seals closing the envelope can be made at a suitably selected distance from the tray edges. Furthermore, the long sides of a tray are more susceptible to deformation than the short ones.

Packaging machines suitable for the Flowpack process include Ilapak Delta 2000 and 3000 or Ulma Baltic, Arctic or Pacific.

A similar application for the films of the present invention is in the MAP packaging of products, like for instance pizza, where the product itself, e.g., in this case the pizza base, acts as the package support and where it is the product itself that may be distorted if films with a too high shrink force are employed in the Flowpack process.

In one embodiment of the present Flowpack packaging process on a HFFS machine, the film of the present invention is used in combination with an innermost gas-permeable packaging film, to provide packages such as those described for instance in EP0755875.

In a preferred embodiment of the third object, the present invention is directed to a tray lidding packaging process, which comprises:

(I) providing a tray with a heat-sealable rim
(II) loading said tray with the product to be packaged
(III) applying a lid on top of said tray,
(IV) heat-sealing said lid to the tray rim, optionally modifying the atmosphere between said lid and said tray, thus providing a package and
(V) heat shrinking the package, simultaneously or subsequently to the sealing step,
in which the lid is a film according to the first object of the present invention.

Tray lidding of in-line thermoformed or pre-made trays is another packaging process where a heat-shrinkable film with a controlled shrink force in the transverse direction is desired.

In this case, the tray with the product loaded therein is brought into a lid sealing station, which comprises a lower chamber and an upper chamber, and a web of the film of the invention is provided over the top of the tray. The lower chamber and the upper chamber are then closed together, air in-between the tray and the lidding film is replaced by the suitable gas or gas blend, with or without prior air evacuation, and then the lidding film is sealed to the rim or the peripheral lip of the tray by means of the combination of a heated frame or platen above the lidding film and a similarly framed anvil supporting the tray rim or peripheral lip, that are pressed together. The lidding film is cut almost at the same time as the lid is sealed and shrinkage of the lid in the package typically occurs at the same time as the heat of the sealing elements in the lidding station is sufficient to get the desired shrinkage. However, a further heat-shrinking step may be added in case of need.

Lidding machines that can suitable for the tray lidding process include for instance Multivac 400 and Multivac T550 by Multivac Sep. GmbH, Mondini Trave, E380, E390 or E590 by Mondini S.p.A., Ross A20 or Ross S45 by Ross-Reiser, Meca-2002 or Meca-2003 by Mecaplastic, the tray lidding machines manufactured by Sealpac and the like machines.

In one embodiment of the present tray lidding packaging process, the film of the present invention is used in combination with an innermost gas-permeable lidding film.

The present gas-barrier film may also be used in combination with a suitable heat-sealable oxygen permeable film, both in a Flowpack process such as the one described in EP0755875A1 or in the tray lidding process for meat packaging described in EP-B-690012 or in WO2006/87125 where a twin lidding film composed of an innermost oxygen permeable film and of an outer gas-barrier film is used to close a high oxygen content meat package by heat-sealing said twin lidding film to the tray rim so as to bind a confined volume within the package containing at least an amount of oxygen effective to inhibit discoloration of the meat.

Finally, in a further embodiment, the present film is suitable for manufacturing shrinkable packaging bags according to methods known in the art, for instance as described in WO2015107127 A1 and in other patents mentioned therein.

In a fourth object, the present invention is directed to a package comprising the film of the first object and a product packaged therein, preferably a food product.

Preferably, the package is made on horizontal form-fill-seal machines (Flowpack) or is a tray-lidded package or is made starting from a pre-made shrinkable flexible container such as a bag or a pouch. Due to the optimal balance of properties of the present film, the present tray lidded or Flowpack tray-including packages have a very attractive appearance, being not distorted by the shrunk film and in the meantime being sufficiently tensioned even after storage at fridge temperatures.

The tray suitable for the packages of the invention may have a rectangular shape or any other suitable shape, such as round, square, elliptical etc.

Commercially available trays are manufactured through common techniques such as thermoforming or injection molding.

The tray can be made of a single layer or, preferably, of a multi-layer polymeric material.

In case of a single layer material, suitable polymers are for instance polystyrene, polypropylene, polyesters, high density polyethylene, poly(lactic acid), PVC and the like, either foamed or solid. Particularly used trays for Flowpack and tray lidding packaging are mono-PP trays.

Also paper- or cardboard-based containers can be used in combination with the films according to the present invention.

Preferably, the tray is provided with gas barrier properties. As used herein such term refers to a film or sheet of material which has an oxygen transmission rate of less than 200 cc/m²-day-bar, less than 150 cc/m²-day-bar, less than 100 cc/m²-day-bar as measured according to ASTM D-3985 at 23° C. and 0% relative humidity.

Suitable materials for gas barrier monolayer thermoplastic trays are, for instance, polyesters, polyamides and the like.

The tray can alternatively made of a multi-layer material. Suitable polymers are for instance ethylene homo- and co-polymers, propylene homo- and co-polymers, polyamides, polystyrene, polyesters, poly(lactic acid), PVC and the like. Part of the multi-layer material can be solid and part can be foamed. For example, the tray can comprises at least one layer of a foamed polymeric material chosen from the group consisting of polystyrene, polypropylene, polyesters, poly(lactic acid), and the like.

The multi-layer material can be produced either by coextrusion of all the layers using well-known coextrusion techniques or by glue- or heat-lamination of, for instance, a rigid foamed or solid substrate with a thin film, usually called “liner”.

The thin film can be laminated either on the side of the tray in contact with the product or on the side facing away from the product or on both sides. In the latter case the films laminated on the two sides of the tray can be the same or different. A layer of an oxygen barrier material, for instance (ethylene-co-vinyl alcohol) copolymer, is optionally present to increase the shelf life of the packaged product. Gas barrier polymers that can be employed for the gas barrier layer are PVDC, EVOH, polyamides, polyesters and blends thereof.

PVDC is any vinylidene chloride copolymers wherein a major proportion of the copolymer comprises vinylidene chloride and a minor amount of the copolymer comprises one or more unsaturated monomers copolymerisable therewith, typically vinyl chloride, and alkyl acrylates or methacrylates (e.g. methyl acrylate or methacrylate) and the blends thereof in different proportions. Generally, a PVDC barrier layer will contain plasticisers and/or stabilizers as known in the art.

The thickness of the gas barrier layer will be set in order to provide the tray with an oxygen transmission rate suitable for the specific packaged product.

Generally, the heat-sealable layer will be selected among the polyolefins, such as ethylene homo- or co-polymers, propylene homo- or co-polymers, ethylene/vinyl acetate copolymers, ionomers, and the homo- and co-polyesters, e.g. PETG, a glycol-modified polyethylene terephthalate. As used herein, the term “copolymer” refers to a polymer derived from two or more types of monomers, and includes terpolymers. Ethylene homopolymers include high-density polyethylene (HDPE) and low-density polyethylene (LDPE). Ethylene copolymers include ethylene/alpha-olefin copolymers and ethylene/unsaturated ester copolymers. Ethylene/alpha-olefin copolymers generally include copolymers of ethylene and one or more comonomers selected from alpha-olefins having from 3 to 20 carbon atoms, such as 1-butene, 1-pentene, 1-hexene, 1-octene, 4-methyl-1-pentene and the like.

Ethylene/alpha-olefin copolymers generally have a density in the range of from about 0.86 to about 0.94 g/cc.

The term linear low density polyethylene (LLDPE) is generally understood to include that group of ethylene/alpha-olefin copolymers which fall into the density range of about 0.910 to about 0.930 g/cc and particularly about 0.915 to about 0.925 g/cc. Sometimes linear polyethylene in the density range from about 0.930 to about 0.945 g/cc is referred to as linear medium density polyethylene (LMDPE). For density lower than about 0.910 g/cc, ethylene/alpha-olefin copolymers may be referred to as very low-density polyethylene (VLDPE) and ultra-low density polyethylene (ULDPE). Ethylene/alpha-olefin copolymers may be obtained by either heterogeneous or homogeneous polymerization processes. Another useful ethylene copolymer is an ethylene/unsaturated ester copolymer, which is the copolymer of ethylene and one or more unsaturated ester monomers. Useful unsaturated esters include vinyl esters of aliphatic carboxylic acids, where the esters have from 4 to 12 carbon atoms, such as vinyl acetate, and alkyl esters of acrylic or methacrylic acid, where the esters have from 4 to 12 carbon atoms.

Ionomers are copolymers of an ethylene and an unsaturated monocarboxylic acid having the carboxylic acid neutralized by a metal ion, such as zinc or, preferably, sodium.

Useful propylene copolymers include propylene/ethylene copolymers, which are copolymers of propylene and ethylene having a majority weight percent content of propylene, and propylene/ethylene/butene terpolymers, which are copolymers of propylene, ethylene and 1-butene. Additional layers, such as adhesive layers, to better adhere the gas-barrier layer to the adjacent layers, may be present in the gas barrier material of the tray and are preferably present depending in particular on the specific resins used for the gas barrier layer.

In case of a multilayer material used to form the tray, part of this structure can be foamed and part can be un-foamed. For instance, the tray may comprise (from the outer layer to the innermost food-contact layer) one or more structural layers, typically of a material such as foam polystyrene, foam polyester or foam polypropylene, or a cast sheet of e.g. polypropylene, polystyrene, poly(vinyl chloride), polyester or cardboard; a gas barrier layer and a heat-sealable layer.

Preferably, the tray is obtained from a sheet of foamed polymeric material having a thin film (called “liner”) comprising at least one oxygen barrier layer and at least one surface sealing layer laminated onto the side facing the packaged product, so that the surface sealing layer of the film is the food contact layer the tray. A second liner, either barrier or non-barrier, can be laminated on the outer surface of the tray. Typical total thickness for the liner is comprised between 10 and 60 microns, preferably 15 to 50 microns.

In general, the typical trays used for lidding or skin applications containing foamed parts, have a total thickness lower than 8 mm, and for instance may be comprised between 0.5 mm and 7.0 mm and more frequently between 2.0 mm and 6.0 mm.

In case of rigid tray not containing foamed parts, the total thickness of the single-layer or multi-layer thermoplastic material is preferably lower than 2 mm, and for instance may be comprised between 0.2 mm and 1.2 mm and more frequently between 0.3 mm and 1.0 mm.

Particularly preferred trays to be used in combination with the films of the present invention for the Flowpack or tray lidding application are polypropylene-, polystyrene- or paper-based either foamed or unfoamed, having a barrier liner. Preferably, the barrier resin of the liner is EVOH.

Optionally, the package may further comprise a soaker pad to absorb product drip loss.

In a fifth object, the present invention is directed to the use of the film according to the first object, in a packaging process, preferably in a packaging process on a horizontal form-fill-seal machine HFFS or in a tray lidding packaging process, where the film is optionally used in combination with an innermost gas-permeable packaging film, or in the manufacture of shrinkable flexible containers.

### Experimental Part

In order to evaluate the films according to the present invention the following test methods were used.

Free shrink (%): the % free shrink, i.e., the irreversible and rapid reduction, as a percent, of the original dimensions of a sample subjected to a given temperature under conditions where nil restraint to inhibit shrinkage is present, was measured according to standard ASTM method D 2732, by immersing for 5 seconds specimens of the films (100 mm×100 mm) into a bath of water or oil at the temperatures of 85° C. or 95° C. or 105° C. The % free shrink was measured in both the longitudinal (machine) and transverse directions of the film. Three specimens in LD and three specimens in TD were measured for each film.

The percent free shrink is defined, for each direction, as the unrestrained linear shrinkage of the film and it is calculated by the formula [(Lₒ−L_{f})/Lₒ]×100 wherein Lₒ is the initial length of the film specimen in mm before the test and L_{f} is the length of the film specimen in mm after shrinking. The average results of this test are reported in Tables 8, 9a to 9c and 10a, 10b.

Punctual shrink tension (kg/cm²), maximum shrink tension (kg/cm²) and residual shrink tension (at 5° C.) (Kg/cm²) were measured through an internal method.

The punctual shrink tension is the shrink tension measured during the test described herein below at a specified temperature, for example 85° C., 95° C. or 105° C.

The maximum shrink tension is the maximum value of the tension developed by the materials during the heating/shrinking process. Specimens of the films (2.54 cm×14.0 cm, of which 10 cm are free for testing) are cut in the longitudinal (LD) and transverse (TD) directions of the film and clamped between two jaws, one of which is connected to a load cell. The two jaws keep the specimen in the center of a channel into which an impeller blows heated or cold air and two thermocouples measure the temperature. The thermocouples are positioned as close as possible (less than 3 mm) to the specimen and in the middle of the same. The signals supplied by the thermocouples (which is the testing temperature) and by the load cell (which is the force) are sent to a computer where the software records these signals. The impeller starts blowing hot air and the force released by the sample is recorded in grams. The temperature is increased from 23° C. to 180° C. or to 105° C., as hereinafter specified, at a rate of about 2.5° C./second by blowing heated air and then decreased from 180° C. or from 105° C. to 5° C. at a rate of 1.5° C./second by blowing cold air.

The punctual shrink tension is calculated by dividing the force value in kg measured at the specified temperature (for ex. 85° C. or 95° C. or 105°) by the specimen width (expressed in cm) and by the specimen average thickness (expressed in cm) and is expressed as kg/cm2.

The maximum shrink tension is calculated by dividing the maximum force value in kg (force at peak) by the specimen width (expressed in cm) and by the specimen average thickness (expressed in cm) and is expressed as kg/cm².

The residual shrink tension is calculated by dividing the force value in Kg measured by the instrument at 5° C., by the specimen width (expressed in cm) and by the specimen average thickness (expressed in cm) and is expressed as kg/cm². Three specimens were measured for each film in both LD and TD directions. The average results of this test are reported in Tables 8, 9a to 9c and 10a, 10b, where the ramp used (to 180° C. or to 105° C. is specified).

Tensile Strength and Elongation at break (ASTM D 882).

Tensile strength represents the maximum tensile load per unit area of the original cross-section of the test specimen required to break it, expressed as kg/cm².

Elongation at break represents the increase in length of the specimen, measured when rupture occurred expressed as percentage of the original length. Measurements were performed with Instron tensile tester equipped with a load cell type CM (1-50 kg), in an environmental chamber set at 23° C., on specimens previously stored at 23° C. and 50% RH for minimum of 24 hours. Tensile and elongation measurements were recorded simultaneously and the reported results are the average values. The average results of this test are reported in Tables 8, 9a to 9c and 10a, 10b.

Elastic modulus at 23° C.: it has been evaluated following ASTM D 882. The average results of this test are reported in Tables 8, 9a to 9c and 10a, 10b.

Haze: it has been evaluated at 85° C. in water following ASTM D1003. The average results of this test are reported in Tables 8, 9a to 9c and 10a, 10b.

Gloss 60°: it has been evaluated following ASTM D2457. The average value of the measurements performed in longitudinal and transversal direction was reported. The average results of this test are reported in Tables 8, 9a to 9c and 10a, 10b.

### Antifog Test (Score)

A packaging film is defined as “antifog” if its internal surface allows the droplets of water to lay as a smooth and uniform layer allowing visual inspection of the packaged product.

An internal test method was used to evaluate the antifog performance of the coated film.

250 ml of water were placed in a 900 ml glass vessel. The film was then secured through a rubber band tightly over the vessel; the sealant side of the film was placed towards the water without being into contact with the liquid. The vessel was then placed in a refrigerated cooler at 2-4° C. Three vessels were prepared for each film.

The specimens so prepared were then observed after 1, 24 and 48 hours or at least for 24 hours and scored by three panellists according to the following rating scale, ordered from very poor to excellent antifog properties:

score 1 opaque layer of small fog droplets;
score 2 opaque or transparent layer of large droplets;
score 3 complete layer of large transparent droplets;
score 4 randomly distributed or large transparent droplets;
score 5 transparent film without visible water.

The final antifog score is the average of three panellists' judgment. The results of this test are reported in Table 8.

### Hermeticity

Hermeticity of the seals of tray lidding packages was evaluated according to an internal test method. The packages were manufactured on a Sealpac A7 (outside cut, fiberglass insulator and convex seal bar 4 mm wide) at 165° C. of sealing temperature and 0.5 seconds of sealing time. The films according to the present were sealed onto mono-PP black 1826-45 tray by ESPlastic, thickness 400/450 microns at flange and onto Cryovac 1826-37 polypropylene trays with PE liner. The seals were “clean”, i.e. the films were sealed onto the tray keeping the tray flange in clean (i.e. non-contaminated) conditions (no product was packaged) or contaminated (in such a case tray flange was contaminated by applying beef blood onto 3 cm of the tray flange in the middle of LD and TD side of the tray, alternatively, before the sealing step). A small piece of beef is dipped into beef blood and then immediately dragged onto the tray flange for about 3 cm of length. The packages so obtained were put in a closed water tank. Vacuum was created in the headspace of the water tank and the value of the pressure (bar) inside the tank when bubbles start to escape the closed packages was recorded. Sixteen packages were tested for each sealing condition and the average pressure value was recorded. The packs fit for use have to stand at least to −0.40 bar in clean conditions and −0.35 bar in contaminated conditions. The average pressure was reported in Tables 12 and 13.

### Compression Test for Trays

The force needed to deform the tray on the long side was measured through an internal method.

The tray was vertically positioned between two supports each attached to one of the two jaws of a dynamometer, clamping the tray on the long sides. Of these two jaws, the upper one was able to move in compression mode and the lower one was fixed. The supports attached to the jaws had a square 5 cm×5 cm base where a recess 3 mm wide and 3 mm deep has been obtained in the center of each base. The flange of each of the two long sides was positioned into the recess of each of the two supports paying attention to center the middle point of the long side into the support and to keep the tray perfectly vertical over the plane of the instrument. The instrument was set up in compression mode (the upper jaw moving down for a specified stroke) and the speed of compression was kept constant at 300 mm/min. A preload of 30 gr was applied before starting the test and the stroke of compression was 8 mm, corresponding to the deformation of the tray in mm. The instrument recorded the force (gf) applied by the instrument to compress the tray. Six trays were measured for each of the two tested tray types: mono-PP black 1826-45 tray by ESPlastic, thickness of 450 microns at flange and mono-PP black 1826-50 tray by Faerch, thickness 700 microns at flange.

The average force values (go were 640 gf for mono-PP black 1826-50 tray Faerch and 275 gf for mono-PP black 1826-45 tray by ESPlastic, demonstrating that the latter is weaker and consequently it is easier to cause tray distortion and pleats by using heat shrinkable films.

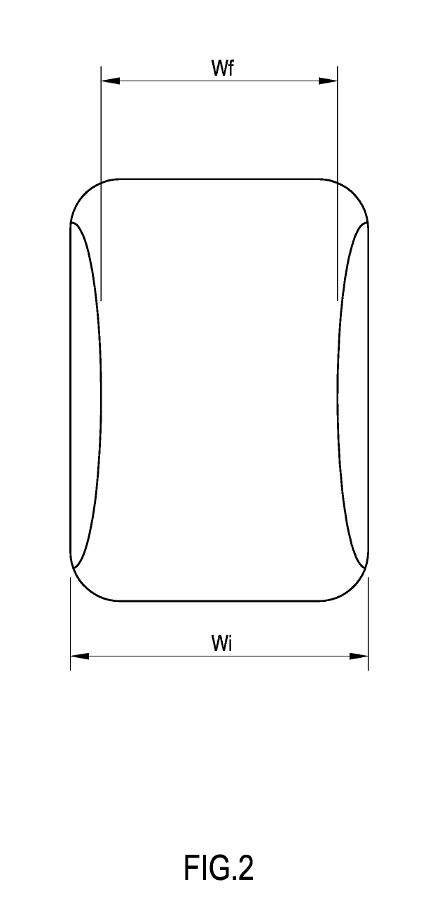

### Tray Distortion (%) (FIG. 2)

The shrinkage of the film during the tray lidding packaging cycle usually deforms the tray in the transverse direction, which corresponds to the long side of the tray.

The tray distortion was evaluated on 40 tray lidded packages manufactured through the films of the present invention and the following trays:
mono-PP black 1826-45 tray by ESPlastic, thickness of 450 microns at flange and
mono-PP black 1826-50 tray by Faerch, thickness 700 microns at flange,
   according to the packaging test hereinafter described.

Immediately after the packaging cycle, in a room at about 10° C., and after 24 hours (during which the package has been kept at 4° C.), the tray width was measured in the point of the flange where the distortion was higher. The tray distortion was the percentage variation of the tray width vs the original one and it was calculated according to the following formula:

((Wᵢ−W_{f})/Wᵢ)×100

where Wᵢ is the initial maximum tray width in cm (for ex. 15 cm), W_{f} is the minimum tray width measured on the package after the packaging cycle (for example 14 cm) (see FIG. 2). The average of the tray distortion values measured on the 40 packages was then calculated. A maximum of 4% of tray distortion was considered “good”, values lower than 3% were considered “very good”.

The packages were manufactured on a Sealpac A7 (outside cut, fiberglass insulator, convex seal bar 4 mm wide) at 165° C. of sealing temperature and 0.5 seconds of sealing time. Table 14 reports the result of these checks.

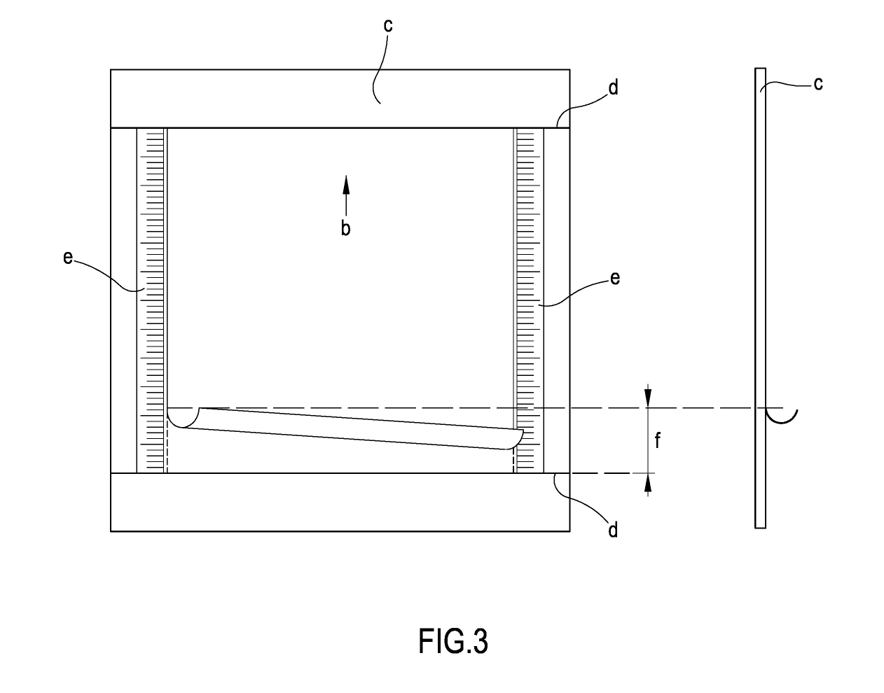

Curling (FIG. 3) was measured according to an internal test method.

Curling is the rolling up which may take place when the edges of a piece of film are let naturally free from any constraint. The test is carried out in a conditioned room at 23° C. and 50% R.H. The films to be tested were taken at least 24 hours in such conditions before testing.

The FIG. 3 illustrates this test.

Each specimen having dimensions 25 cm×25 cm is cut out from a film roll with the help of the metallic plate sized 25 cm×25 cm and of a cutter. Three specimens for the measurement of the curling in the longitudinal direction and three specimens for the measurement of the curling in the transverse direction were prepared

The specimen is then put onto an aluminum plate sized 30×30 cm coated with Teflon (which prevents the electrostatic attraction between the film and the metallic platform). The aluminum plate also reports a ruler, as shown in the FIG. 3.

The specimen must be positioned:
between the marking lines and in such a way that the curling, if any, occurs facing the operator (i.e. not towards the platform);
when testing LD samples, the longitudinal direction must be parallel to the ruler, while for TD measurements, the transverse direction must be parallel to the ruler.

Then the operator measures the curling (distance f, see FIG. 3) taking the measures at the points where the film is lifting up from the platform. In particular, “f” values are measured both at the left and at the right side and the highest of these values in cm is recorded (f max). From this value (f max) the percentage compared to the dimension of the sample in that direction is calculated according to this formula: (fmax/25)×100.

In case fmax is 25, curling is 100%, meaning that the specimen is completely rolled.

The operator also takes notes of the direction of the curling of the films, i.e. he reports if the specimen rolls up towards the interior or the exterior of the roll.

FIG. 3 illustrates this test for the evaluation of the curling in longitudinal direction (machine direction) (keys: a) film roll (not represented); b) Specimen (with the arrow representing the machine direction of the film in the roll and on the platform); c) Teflon coated platform, lying on the table; d) marking lines; e) scales (rulers); f) curling.

Three specimens for each one of the longitudinal and transverse directions were measured for each film and the average % curling value was reported in Tables 8, 9a, 10a and 10b.

### Pack Relaxation

Onto the same packages evaluated for tray distortion, pack relaxation was also assessed by two panelists.

The pack relaxation was evaluated by visual check of the package by observing if pleats or wrinkles or waving effect were visible on the film surface. The pack relaxation was evaluated on 40 tray lidding packages manufactured according to the packaging test hereinbefore described.

The packages were put into the fridge at 4° C. and observed after 24 hours. The evaluation immediately after the packaging in a room at 10° C. was also done (0 h). A score was assigned according to the scale below:
4 for “no pleats”,
3 for “few pleats”
2 for “some pleats”,
1 for “several pleats”.

The packages were judged as “good” if few or no pleats were observed (score 3 and 4) and “bad” in case of pleats affecting the film surface of the package (score 2 and 1).

Table 14 reports the result of these checks (average score was calculated from scores assigned by each panelist to each package).

### Flange Deformation

Onto the same packages evaluated for tray distortion, the flange deformation (flange tilted up or seriously distorted/scratched) was also assessed by two panelists.

The flange deformation was evaluated on 40 tray-lidding packages manufactured according to the packaging test hereinbefore described.

The packages were put into the fridge at 4° C. and observed after 24 hours. The evaluation immediately after the packaging in a room at 10° C. was also done (0 h). A score was assigned according to the scale below:
2 for excessive deformation,
1 for medium deformation
0 for no deformation,

Table 14 reports the result of these checks (average values calculated from scores assigned by each panelist to each package). The packages were judged as “good” if the average calculated score was at most 1.

None of the tested film resulted in packages having score 2 as to flange deformation.

### Drum Effect

The “drum effect” refers to the sound that a package with a highly tensioned shrunk film wrapped around or sealed to a tray emits when hand beaten like a drum.

This test represents a simple but reliable tool for evaluating the tightness of a package: only tensioned films emits a drum-like sound otherwise no sound or only a muffled tone is produced when the film is beaten. Tests were performed on the packages after 20 minutes and 24 hours.

This test was evaluated on 40 tray lidding packages manufactured according to the packaging test hereinabove described. All the tray-lidded packages manufactured with the film according to the present invention emitted a drum-like sound when beaten.

### Flowpack Packaging Test

Some films according to the present invention were used to manufacture Flowpack packages in order to evaluate the machinability and the percentage of rejects.

200 packages for each tested film were manufactured, each containing wood dummies 90 mm wide, 14 cm long and 3 cm thick. The machine used was ILAPAK DELTA 3000LD HFFS machine with the following settings:
pouch length: 210 mm,
temperature of the two transverse sealing bars (lower and upper, height 30 mm): 145° C.,
temperature of the two pairs of longitudinal sealing rollers: 120° C. for the first pair and 140° C. for the second pair,
line speed: 50 ppm (pack per minute) and 70 ppm, as reported in Table 11.
shrinking tunnel (CJ53 model) having 3 stations at three increasing temperatures, respectively: 145° C., 150° C., 155° C., speed of the belt of about 8 meters/minute),
Constant shrinking time in the 3 stations and corresponding to about 10.5 m/min of film unwound from the roll,
Active trimming unit 50° C.
Film tension 0.8-1 kg;
Film roll features: width 450 mm, length 1900 linear meters, core 6 inches, sealant of the film on the external side.

No tray was used to manufacture the packages during this test.

After having created 150 empty packages in continuous without any machinability issue or interruptions, the dummies are loaded onto the machine and the final packages are manufactured. The packages so obtained are then inflated with compressed air set at 0.04 MPa by means of a gun. Such a pressure level has proven to be the optimal value to detect micro-leaks without damaging the seals.

The gun is connected to compressed air line (a manometer set at 1 bar is installed on the air intake) and air is injected into the packages through a needle of the gun. The gun is equipped with a manometer to measure the compressed air pressure.

The inflated packages are then immersed into a water tank kept at ambient temperature. If the pack has a leak, a steady stream of air bubble is observed escaping from the point of the leak.

The detected leaks are categorized depending on the location of occurrence:
I identifies leaks occurring at the intersection across the transverse and the longitudinal seals;
T identifies leaks occurring at the transverse seals;
L identifies leaks occurring at the longitudinal seals.

At the end of the tests, the average value (approximated to the nearest integer figure) of leaks occurring in each location is reported.

Table 11 reports such values for each package and the % of packages with no leaks. In the same Table, “other defects” means rejects not due to the seals failure but due to film perforation not occurring at the sealing areas. For all the tested films, no significant leaks occurred.

Optics after Flowpack Cycle (Haze after Shrink)

Some films according to the present invention were used to manufacture Flowpack packages in order to evaluate the optical properties (haze and gloss 60°) after the Flowpack cycle on ILAPAK DELTA 3000LD HFFS machine.

No tray was used to manufacture the packages during this test. The packages manufactured for this test from the films of Ex. 9, Ex. 10 and Ref. 1 (Table 9a) contained wood dummies 150 mm wide, 15 cm long and 2 cm thick.

The machine was used with the following settings:
pouch: length 210 mm and width 150 mm,
temperature of the two transverse sealing bars (lower and upper, height 30 mm): 145° C.,
temperature of the two pairs of longitudinal sealing rollers: 120° C. for the first pair and 140° C. for the second pair,
line speed: 50 ppm (pack per minute),
shrinking tunnel (CJ53 model) having 3 stations at three increasing temperatures, respectively: 145° C., 150° C., 155° C., line of the belt speed 6 corresponding to about 8 meters/minute),
Constant shrinking time in the 3 stations and corresponding to about 10.5 m/min of film unwound from the roll,
Active trimming unit 50° C.
Film tension 0.8-1 kg;
Film roll features: width 450 mm, length 1900 linear meters, core 6 inches, sealant of the film on the external side.

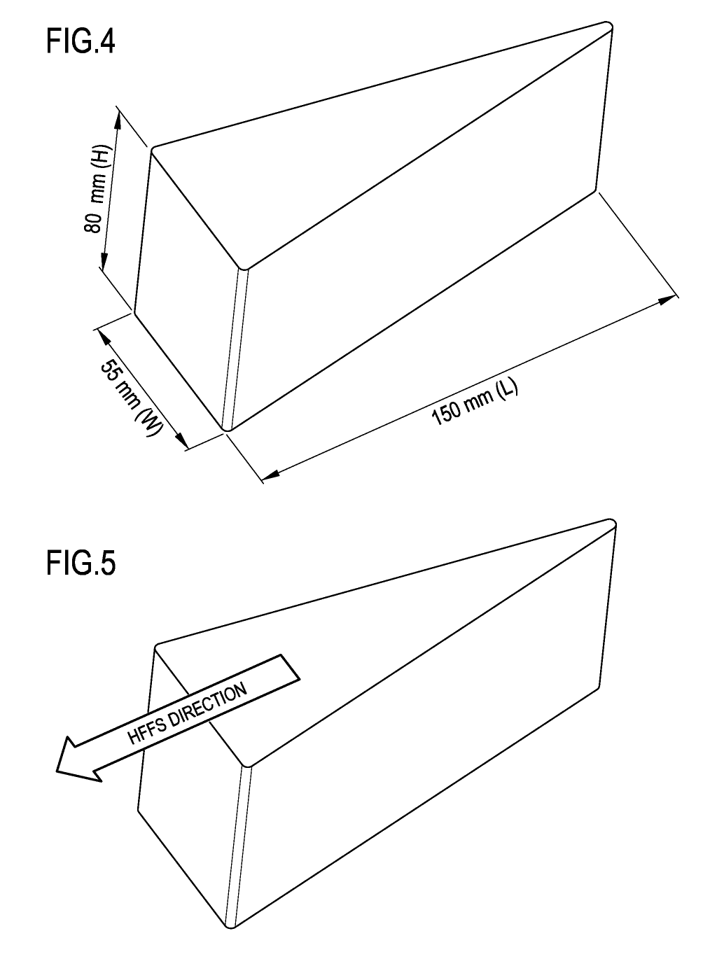

The packages manufactured for this test from the films of Ex. 19 to Ex. 26 (Tables 9b and 9c) contained triangular wood dummies (150 mm×80 mm×55 mm see FIG. 4 for dimensions). The position of the dummy during packaging was as reported in FIG. 5.

The machine was used with the following settings:
pouch dimensions: length 270 mm×width 140 mm
temperature of the two transverse sealing bars (lower and upper, height 30 mm): 145° C.
temperature of the two pairs of longitudinal sealing rollers: 135° C. for the first pair and 145° C. for the second pair
line speed: 25 ppm (pack per minute)
perforator: 160° C. (cams position: 300°/90°)
shrinking tunnel (CJ53 model) having 3 stations at three increasing temperatures, respectively: 150° C., 155° C., 160° C., line of the belt speed 3 corresponding to about 4 meters/minute
air flow: 1st station: 100% air from bottom, 2nd station: ½ air from bottom ½ from side, 3rd station 100% air from side and top
Constant shrinking time in the 3 stations and corresponding to about 10.5 m/min of film unwound from the roll
Active trimming unit 50° C.
Film tension 0.8 kg
Film roll features: width 450 mm, length 1900 linear meters, core 6 inches, sealant of the film on the external side.

After having created 150 empty packages in continuous without any machinability issue or interruptions, the dummies were loaded onto the machine and the final shrunk packages were manufactured.

A few packages were opened in order to test the optical properties of the films, namely haze and gloss after shrink, according to ASTM D 1003. The flat parts of the films obtained from the package were measured. i.e. the parts of the film in contact with the main surface of the wood dummies.

The average value of the optical properties measured for each tested film before or after shrink was reported in Tables 9a-c.

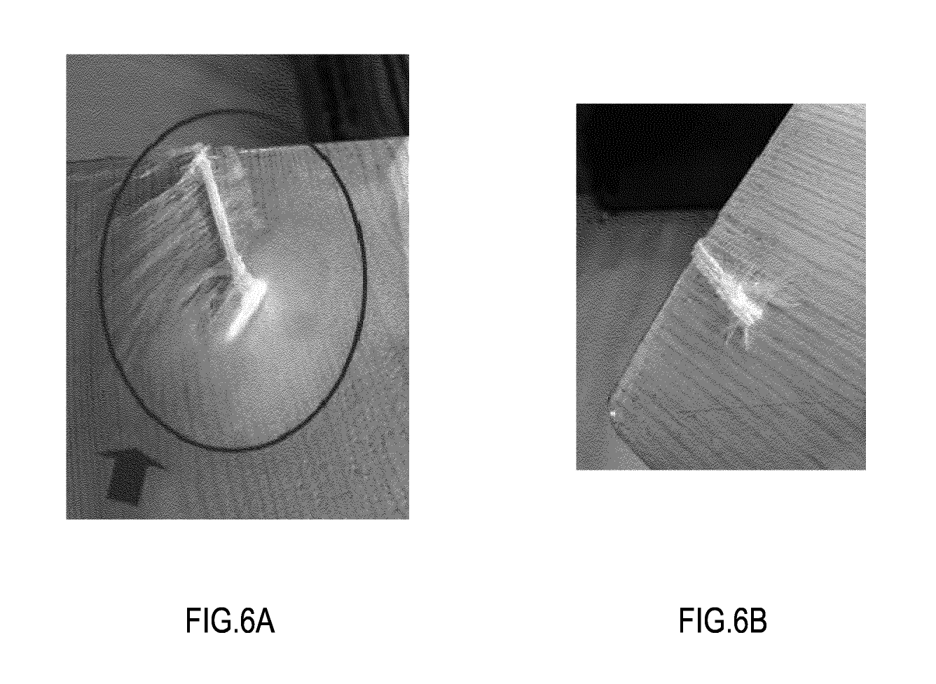

In this packaging process, the particular shape of the product entails that there is exceeding film in the final package. In this respect, we observed that the packages manufactured from the film of Ex.28 showed a slight whitening around the exceeding sealed material while the packages made from film of Ex.29 were perfectly clear (see FIGS. 6A and B showing pictures of these packages with wood dummies, in particular picture 6A in which the whitening effect appears while picture 6B shows a clear package).

### Gel Content Determination

The gel content express the percentage of a polymeric material insoluble in toluene and it is an index of the level of cross-linking of the polymer in that material. In case the material is a multilayer film, the test may be carried out on the entire film or on a part of it, by delaminating the desired layers and by not submitting to the test those layers whose polymers are not soluble in toluene per se, such as for instance EVOH or ionomers.

The result is expressed as percentage by weight of the undissolved material (i.e. the cross-linked material) after toluene treatment with respect to the total weight of the initial material. The test was performed according to the following procedure.

A square of wire metal gauze (80 mesh, 15 cm×15 cm) was cut and cleaned by submersion in a beaker containing toluene. After solvent evaporation, the wire gauze was given a funnel shape and weighted (weight B). 120 ml of toluene were put in a 200 ml beaker and heated on a hot plate.

A sample of the material of about 150 mg was weighted (weight A) and put it in the boiling toluene for 30 minutes, under stirring. The solution was then filtered on the wire gauze and the gel remained on the wire gauze. The wire gauze with the gel was evaporated under hood, weighted (weight C) after 24 h and 48 h up to a constant weight.

The gel content percentage was calculated, for each weighing with the following formula: (C−B)/A×100 and the average value was calculated. The analysis was repeated twice for each material.

The results reported in Tables 8 and 10a are related to the gel content measured on layer 1 and layer 2 peeled away from the other layers of the films and subjected to the test method described above.

### Thermal and Cutting Damage

The performance of the present films in terms of resistance to thermal damages and cutting issues during tray lidding packaging was tested.

Thermal and cutting defects were evaluated on tray lidded packages made of the selected film, a Cryovac tray (PE-based with barrier liner (EVOH), total thickness at flange 550 microns, dimensions Width×Length×Height 18 cm×25 cm×50 mm), without any packaged product.

The empty packages were manufactured on a MONDINI E340 (outside cut, blades new, silicon sponge insulator, convex seal bar 4 mm wide) at 170° C. of sealing temperature, 0.5 seconds of sealing time, Vacuum: 305 mbar, Gas: 615 mbar, compensation delay (time between gas flushing higher vs lower cells): 0.5 sec.

A group of three panellists evaluated for each package:
the presence of holes in the film close to the seal area (thermal damages due to the seal bars)
the presence of film in the packages not separated from the film skeleton (cutting issues).

If at least one of the above defects was present, the package was judged as defective.

The total number of defective packages for each film, as an average of the three panelists' judgment, is reported in Table 10b together with the percentage of rejects. This test is very severe: a percentage of defective packages (rejects) up to 50% is considered good and up to 75% still acceptable.

### Examples

The Examples that follow are aimed at better illustrating some representative embodiments of the present invention. Unless otherwise indicated, all parts and percentages are by weight.

In the films of the following examples, the resins indicated in Table 1 below were included.

TABLE 1

| Tradename | Supplier | Acronym |
|---|---|---|
| Eltex PF6220AA | Ineos | LLDPE1 |
| AF5841LL | TOSAF | LLDPE AF |
| DOWLEX 2045S | DOW | LLDPE2 |
| Dowlex 5057GC | DOW | LLDPE3 |
| EXCEED 4518PA | ExxonMobil | LLDPE4 |
| EXCEED 2018CA | ExxonMobil | LLDPE5 |
| Eltex PF6220AA | Ineos | LLDPE6 |
| Exceed 2018HA | ExxonMobil | LLDPE7 |
| Lumicene M1820EP | Total Petrochemicals | LLDPE8 |
| Enable 20-05CH | ExxonMobil | LLDPE9 |
| RAMAPET N180 | Indorama | PET1 |
| Sukano T Dc S479 | Sukano | PET1 MB |
| RAMAPET N1 | Indorama | PET2 |
| POINTPLASTIC HIP 7090 | Point Plastic | PET3 |
| Elecut ZE-107C | Takemoto Oil & Fat | PET imp mod |
| GN001 | Eastman Chemical | PETG1 |
| SUKANO G dc S503 | Sukano | PETG2 |
| SOARNOL AT4403 | Nippon Gohsei | EVOH1 |
| EVAL SP292B | EVALCA/Kuraray | EVOH2 |
| GRILON CF6S | EMS-Grivory | PA 6/12 |
| IXAN PV910 | Solvin | PVDC-MA |
| AFFINITY PL 1845G | DOW | VLDPE1 |
| AFFINITY PL 1281G1 | DOW | VLDPE2 |
| AFFINITY PL 1880G | DOW | EAO1 |
| ELTEX PKS359 | Ineos | EPC1 |
| VERSIFY 3000 | DOW | EPC2 |
| ELTEX P KS350 | Ineos | EPC3 |
| Infuse 9100.05 | DOW | OBC1 |
| CC10211853BG FDM | PolyOne Corp | PP |
| PPC 06 99 B | | |
| NUCREL 1202 | DuPont | EMAA1 |
| BYNEL CXA 21E787 | DuPont | EMA-md1 |
| ADMER AT 2146E | Mitsui Chemical | LLDPE-md1 |
| Plexar PX3227X09 | LyondellBasell | LLDPE-md2 |
| | Industries | |
| ADMER NF911E | Mitsui Chemical | LLDPE-md3 |
| ESCORENE ULTRA FL00119 | ExxonMobil | EVA1 |
| ELVAX 3170 | Du Pont | EVA2 |

### Resins Composition and Properties

LLDPE1: Density 0.919 g/cc, Melt Flow Rate 2.1 g/10 min (190° C./2.16 kg), Melting point 116° C.
LLDPE AF: Density 0.920 g/cc, Melt Flow Rate 3.0 g/10 min (190° C./2.16 kg)
LLDPE2: Density 0.9200 g/cc, Melt Flow Rate 1.00 g/10 min (190° C./2.16 kg), Melting Point 124.0° C., Vicat softening point 103° C.
LLDPE3: Density 0.9158 g/cc, Melt Flow Rate 2.11 g/10 min (190° C./2.16 kg)
LLDPE4: Density 0.918 g/cc, Melt Flow Rate 4.50 g/10 min (190° C./2.16 kg), Melting point 114.0° C.
LLDPE5: Density 0.918 g/cc, Melt Flow Rate (Cond. 190° C./02.16 kg (E)) 2 g/10 min, Melting Points 108° C. and 118° C.
LLDPE6: Density 0.919 g/cc, Melt Flow Rate 2.1 g/10 min (190° C./2.16 kg)
LLDPE7: Density 0.918 g/cc, Melt Flow Rate 2.0 g/10 min (190° C./2.16 kg), Melting point 117° C.
LLDPE8: Density 0.918 g/cc, Melt Flow Rate 2.0 g/10 min (190° C./2.16 kg), Melting point 110° C.
LLDPE9: Density 0.920 g/cc, Melt Flow Rate (190° C./2.16 kg) 0.50 g/10 min, Melting point 114° C.
PET1: Density 1.4 g/cc, Viscosity Solution 0.80 mPa·sec, Glass Transition 78° C., Melting point 245° C.
PET1 MB: SiO2 10%, Glass transition temperature (DSC) approx. 80° C., Specific gravity at 20° C. g/cc approx. 1.45, Bulk density kg/m3 approx. 775
PET2: Density 1.39 g/cc, Melting Point 2.47° C., Viscosity Solution (Brookfield) 0.80 mPA·sec
PET3: Density 1.39 g/cc, Melting point 238° C., Intrinsic Viscosity 0.90 dl/g
PET impact modified: Plasticizer Masterbatch based on polyethylene terephthalate (I.V.=0.8 dl/g)
PETG1: Density 1.27 g/cc, Glass Transition 78° C., Intrinsic Viscosity 0.75 dl/g
PETG2: Additives (SiO2) 10%, Additives(Wax) 6%, Bulk (Apparent) Density 0.74 g/cc, Density 1.4 g/cc, Vicat softening point 82° C.
EVOH1: Crystallization point 144° C., Density 1.140 g/cc, Melting point 164° C., Melt Flow Rate 3.5 g/10 min (210° C./2.16 kg), Comonomer content 44%.
EVOH2: Comonomer content (Ethylene) 44%, Density 1.14 g/cc Melt Flow Rate 2.1 g/10 min (190° C./2.16 kg), Melt Flow Rate 4.5 g/10 min (200° C./2.16 kg), Melting point 161° C., Melt Flow Rate 8.2 g/10 min (230° C./2.16 kg)
PA 6/12: Density 1.050 g/cc, Melt Flow Rate 5.75 g/10 min (190° C./5.00 kg), Melt Volume Index 195 ml/10 min (275° C./5.00 kg/10 min), Viscosity Relative 1.80, Melting point 130° C. (10° C./Min)
PVDC-MA: Bulk (Apparent) Density min 0.78 g/cc, Comonomer content 8.1%, Density 1.71 g/cc, Viscosity Relative min-1.44-max 1.48, Viscosity Solution 1.46 mPA·sec.
VLDPE1: Density 0.91 g/cc, Vicat Softening point 95° C., Melting Point 103° C., Melt Flow Rate 3.5 g/10 min (190° C./2.16 kg).
VLDPE2: Density 0.91 g/cc Melt Flow Rate (Cond. 190° C./02.16 kg (E)) 3.5 g/10 min
EAO1: Density 0.902 g/cc, Melt Flow Rate (Cond. 190° C./02.16 kg (E)) 1.1 g/10 min, Melting Point 99° C., Vicat softening point 86° C.
EMAA1: Comonomer content (Methyl Acrylate) 12%, Melting Point 99° C., Density 0.94 g/cc, Vicat Softening point 75° C., Melt Flow Rate 1.5 g/10 min (190° C./2.16 kg)
EMA-md1: Density 0.930 g/cc, Melt Flow Rate 1.6 g/10 min (190° C./2.16 kg), Melting point 92° C., Vicat softening point 52° C.
LLDPE-md1: Density 0.915 g/cc, Melt Flow Rate 1.3 g/10 min (190° C./2.16 kg), Vicat softening point 72° C.
LLDPE-md2: Density 0.9130 g/cc, Melting point 124.0° C., Melt Flow 1.70 g/10 min (190° C./2.16 kg), Vicat softening point 82° C.
LLDPE-md3: Density 0.900 g/cc, Melt Flow Rate 2.5 g/10 min (190° C./2.16 kg), Vicat softening point 74° C.
EPC1: Density 0.895 g/cc, Melt Flow Rate 5 g/10 min (230° C./2.16 kg), Melting point 131° C.
EPC2: Comonomer content 5.2%, Density 0.891 g/cc, Melt Flow Rate 8.0 g/10 min (230° C./2.16 kg), Melting point 108° C., Melt Flow Rate 8.0 g/10 min (230° C./2.16 kg), Glass Transition −14° C., Vicat softening point 105° C.
EPC3: Density 0.895 g/cc, Melt Flow Rate 5.0 g/10 min (230° C./02.16 kg), Melting point 131° C., Vicat softening point 105° C.
OBC1: Density 0.877 g/cc, Melt Flow Rate 1 g/10 min (190° C./2.16 kg), Melting point 120° C.
PP: Density 0.90 g/cc, Melt Flow Rate 16 g/10 min (230° C./2.16 kg)
EVA1: Density 0.942 g/cc, Melting point 85° C., Comonomer content 19%, Melt Flow Rate 0.65 g/10 min (190° C./2.16 kg), Melt Flow Rate 0.650 g/10 min (200° C./2.16 kg), Vicat softening point 62° C.
EVA2: Comonomer content 18% Density 0.94 g/cc, Melt Flow Rate (Cond. 190° C./02.16 kg(E)) 2.5 g/10 min, Melting Point 90° C.

Several asymmetrical structures B/E/A/E/D/E/C, in which B is the sealant, A is the gas-barrier layer, C is the polyester containing layer, D is the inner layer and E is a tie layer were manufactured. Seven comparative films and a reference film, present in the market, were also extruded. Their compositions are reported in Tables 2, 3, 4a, 4b, 4c, 5, 6a, 6b, 7 and 15 as well as their manufacturing conditions. Comparative example 1 is characterized by the sequence B/D/E/A/E/C, wherein the bulk layer (D) is positioned on the other side, i.e. between the seal layer (B) and the barrier layer (A).

Comparative film 2 has a layer (D) made of a methacrylate copolymer.

Comparative film 3 has a layer (D) with a too low thickness ratio while Comparative 4 with a too high thickness ratio.

Comparative film 5 does not include a gas barrier layer (A) but instead a polyolefin based layer.

Comparative 6 has a layer (D) made of a tie (a polyolefin modified with maleic anhydride).

Comparative 7 includes two layers (D), one between the sealant layer (B) and the barrier layer (A) and the other between the barrier layer (A) and the outer layer (C).

The equipment used for the extrusion, orientation, annealing and crosslinking was the same for Ex. 1 to 29 and for the comparative and reference films. Unless otherwise stated, the films were extruded through a round die, quickly quenched, irradiated at 64 KGys, biaxially oriented out of hot air at a selected orientation temperature, annealed, allowing a reduction of the film width in TD as reported in Tables 2 to 7. In such tables, the relevant specific manufacturing conditions applied for each example are shown.

The annealing step was carried out on a processing unit as illustrated in FIG. 1 consisting of a sequence of six stainless steel Gross Equatherm heated rollers and two cooled rollers, 16-cm in diameter and 203-cm in length. The temperature was the same in the three heating zones, each comprising two rollers, and corresponds to the temperature indicated in Tables 2 to 7 below under “annealing temperature”.

Tables 2 to 7 report the films composition, the oven temperature used during the orientation step and the stretching values, the annealing temperature and time and the thickness ratio in percentage of inner layer D, when present.

Tables 2 to 5 report the composition of films according to the present invention that are suitable for Flowpack packaging applications and of Comparative films.

Tables 6a, 6b and 7 report the composition of films according to the present invention that are suitable for tray lidding packaging applications.

Table 15 reports the composition of a Comparative film suitable for manufacturing shrinkable bags but not tray lidded packages and of Comparative films.

During the annealing step, the speed of the couples of rollers 1 and 2, 3 and 4, 5 and 6, 7 and 8 (represented in FIG. 1) was 68 m/min for all the films of Table 2 to 5; for the films of Tables 6 to 7, the speed of the couples of rollers 1 and 2 and 3 and 4 was 68 m/min while it was 62 m/min for rollers 5 and 6 and 7 and 8. The lower speed allowed to reduce the shrink tensions in LD in order to manufacture lidding films suitable for use with soft trays, as mono-PP black 1826-45 tray by ESPlastic.

In the following tables, all the thickness values are expressed in microns. The thickness of each layer is reported in parenthesis.

TABLE 2
Films for_Flowpack packaging applications

| | Ex. 1 | Ex. 2 | Ex. 3 | Ex. 4 | Ex. 5 |
|---|---|---|---|---|---|
| T annealing (° C.) | 50 | 75 | 75 | 75 | 75 |
| Annealing time (s) | 1.5 | 1.5 | 1.5 | 1.5 | 1.5 |
| Film width reduction (%) | 1% | 9% | 11% | 19% | 13% |
| T. oven (° C.) | 112 | 112 | 109 | 109 | 111 |
| Stretching ratio LD, TD | 3.75 × 3.75 | 3.75 × 3.75 | 3.75 × 3.75 | 3.75 × 3.75 | 3.75 × 3.75 |
| layer 1 (B) | 83% | 83% | 83% | 48% LLDPE1 | 83% |
| | LLDPE1 | LLDPE1 | LLDPE1 | 35% VLDPE1 | LLDPE1 |
| | 17% LLDPE | 17% LLDPE | 17% LLDPE | 17% LLDPE | 17% LLDPE |
| | AF (7.2) | AF (7.2) | AF (9.4) | AF (7.2) | AF (7.2) |
| layer 2 (E) | 100% | 100% | 100% | 100% LLDPE- | 100% |
| | LLDPE-md1 | LLDPE-md1 | LLDPE-md1 | md1 (1.4) | LLDPE-md1 |
| | (1.4) | (1.4) | (1.4) | | (1.4) |
| layer 3 (A) | 95% EVOH1 | 95% EVOH1 | 95% EVOH1 | 95% EVOH1 | 95% EVOH1 |
| | 5% PA 6/12 | 5% PA 6/12 | 5% PA 6/12 | 5% PA 6/12 | 5% PA 6/12 |
| | (2.5) | (2.5) | (2.5) | (2.5) | (2.5) |
| layer 4 (E) | 100% | 100% | 100% | 100% LLDPE- | 100% |
| | LLDPE-md1 | LLDPE-md1 | LLDPE-md1 | md1 (1.8) | LLDPE-md1 |
| | (1.8) | (1.8) | (1.8) | | (1.8) |
| layer 5 (D) | 100% | 100% | 100% | 100% | 100% |
| | LLDPE2 | LLDPE2 | LLDPE2 | LLDPE2 (4.7) | LLDPE3 |
| | (4.7) | (4.7) | (4.7) | | (4.7) |
| layer 6 (E) | 100% | 100% | 100% | 100% LLDPE- | 100% |
| | LLDPE-md1 | LLDPE-md1 | LLDPE-md1 | md1 (1.5) | LLDPE-md1 |
| | (1.5) | (1.5) | (1.5) | | (1.5) |
| layer 7 (C) | 98% PET1 | 98% PET1 | 98% PET1 | 98% PET1 | 98% PET1 |
| | 2% PET1 | 2% PET1 | 2% PET1 | 2% PET1 MB | 2% PET1 |
| | MB (2.2) | MB (2.2) | MB (2.2) | (2.2) | MB (2.2) |
| Tot. Thickness | 21.3 | 21.3 | 23.5 | 21.3 | 21.3 |
| % Thickness ratio layer | 22 | 22 | 20 | 22 | 22 |
| 5 (D) | | | | | |

Stretching ratio LD, TD of 3.75 × 3.75 means 3.75:1 in LD and 3.75:1 in TD

TABLE 3
Films for_Flowpack packaging applications

| | Ex. 6 | Ex. 7 | Ex. 8 |
|---|---|---|---|
| T annealing (° C.) | 50 | 75 | 75 |
| Annealing time (s) | 1.5 | 1.5 | 1.5 |
| Film width reduction | 14% | 15% | 12% |
| (%) | | | |
| T oven (° C.) | 111 | 111 | 111 |
| Stretching ratio LD, | 3.75 × 3.75 | 3.75 × 3.75 | 3.75 × 3.75 |
| TD | | | |
| layer 1 (B) | 75% LLDPE1 | 83% LLDPE1 | 48% LLDPE1 |
| | 25% LLDPE | 17% LLDPE | 35% LLDPE4 |
| | AF (7.2) | AF (7.2) | 17% LLDPE |
| | | | AF (7.2) |
| layer 2 (E) | 100% LLDPE- | 100% LLDPE- | 100% LLDPE- |
| | md1 (1.4) | md1 (1.4) | md1 (1.4) |
| layer 3 (A) | 95% EVOH1 | 95% EVOH1 | 95% EVOH1 |
| | 5% PA | 5% PA | 5% PA |
| | 6/12 (2.5) | 6/12 (2.5) | 6/12 (2.5) |
| layer 4 (E) | 100% LLDPE- | 100% LLDPE- | 100% LLDPE- |
| | md1 (1.8) | md1 (1.8) | md1 (1.8) |
| layer 5 (D) | 100% LLDPE2 | 100% LLDPE2 | 100% LLDPE2 |
| | (4.7) | (4.7) | (4.7) |
| layer 6 (E) | 100% LLDPE- | 100% LLDPE- | 100% LLDPE- |
| | md1 (1.5) | md1 (1.5) | md1 (1.5) |
| layer 7 (C) | 92% PET1 | 68% PET1 | 98% PET1 |
| | 2% PET1 MB | 30% PETG1 | 2% PET1 |
| | 6% PET imp | 2% PET1 | MB (2.2) |
| | mod (2.2) | MB (2.2) | |
| Tot. Thickness | 21.3 | 21.3 | 21.3 |
| % Thickness | 22 | 22 | 22 |
| ratio layer 5 | | | |
| (D) | | | |

TABLE 4a
Films for Flowpack packaging applications

| | Ex. 9 | Ex. 10 | Ex. 11 | Ex. 19 |
|---|---|---|---|---|
| T annealing (° C.) | 50 | 75 | 75 | 60 |
| Annealing time (s) | 1.5 | 1.5 | 1.5 | 1.5 |
| Film width reduction (%) | 6% | 20% | 13% | 12% |
| T oven (° C.) | 102 | 102 | 112 | 110 |
| Stretching ratio LD, TD | 3.75 × 3.75 | 3.75 × 3.75 | 3.75 × 3.75 | 3.75 × 3.75 |
| Cross-linking KGy | 64 | 64 | 64 | 30 |
| layer 1 (B) | 48% LLDPE1 | 48% LLDPE1 | 48% LLDPE1 | 75% LLDPE7 |
| | 35% LLDPE4 | 35% LLDPE4 | 35% LLDPE4 | 25% LLDPE |
| | 17% LLDPE | 17% LLDPE | 17% LLDPE | AF (7.1) |
| | AF (7.2) | AF (7.2) | AF (7.2) | |
| layer 2 (E) | 100% LLDPE- | 100% LLDPE- | 100% LLDPE- | 100% LLDPE- |
| | md1 (1.4) | md1 (1.4) | md1 (1.4) | md1 (1.4) |
| layer 3 (A) | 95% EVOH1 | 95% EVOH1 | 95% EVOH2 | 95% EVOH1 |
| | 5% PA | 5% PA | 5% PA | 5% PA |
| | 6/12 (2.5) | 6/12 (2.5) | 6/12 (2.5) | 6/12 (2.5) |
| layer 4 (E) | 100% LLDPE- | 100% LLDPE- | 100% LLDPE- | 100% LLDPE- |
| | md1 (1.8) | md1 (1.8) | md1 (1.8) | md1 (1.8) |
| layer 5 (D) | 100% LLDPE3 | 100% LLDPE3 | 100% LLDPE3 | 100% LLDPE2 |
| | (4.7) | (4.7) | (4.7) | (4.6) |
| layer 6 (E) | 100% LLDPE- | 100% LLDPE- | 100% LLDPE- | 100% LLDPE- |
| | md1 (1.5) | md1 (1.5) | md1 (1.5) | md1 (1.5) |
| layer 7 (C) | 98% PET1 | 98% PET1 | 98% PET1 | 78% PET1 |
| | 2% PET1 | 2% PET1 | 2% PET1 | 20% PETG1 |
| | MB (2.2) | MB (2.2) | MB (2.2) | 2% PET1 |
| | | | | MB (2.1) |
| Tot. Thickness | 21.3 | 21.3 | 21.3 | 21 |
| % Thickness | 22 | 22 | 22 | 22 |
| ratio layer 5 | | | | |
| (D) | | | | |

TABLE 4b
Films for Flowpack packaging applications

| | Ex. 20 | Ex. 21 | Ex. 22 | Ex. 23 | Ex. 24 |
|---|---|---|---|---|---|
| T annealing (° C.) | 60 | 60 | 60 | 60 | 60 |
| Annealing time (s) | 1.5 | 1.5 | 1.5 | 1.5 | 1.5 |
| Film width reduction (%) | 12% | 12% | 12% | 12% | 12% |
| T oven (° C.) | 110 | 110 | 110 | 109 | 108.5 |
| Stretching ratio LD, TD | 3.75 × 3.75 | 3.75 × 3.75 | 3.75 × 3.75 | 3.75 × 3.75 | 3.75 × 3.75 |
| Cross-linking KGy | 30 | 30 | 30 | 30 | 30 |
| layer 1 (B) | 75% LLDPE7 | 75% LLDPE7 | 75% LLDPE7 | 75% LLDPE7 | 75% LLDPE7 |
| | 25% LLDPE | 25% LLDPE | 25% LLDPE | 25% LLDPE | 25% LLDPE |
| | AF (7.1) | AF (7.1) | AF (7.1) | AF (7.1) | AF (7.1) |
| layer 2 (E) | 100% LLDPE- | 100% LLDPE- | 100% LLDPE- | 100% LLDPE- | 100% LLDPE- |
| | md1 (1.4) | md1 (1.4) | md1 (1.4) | md1 (1.4) | md1 (1.4) |
| layer 3 (A) | 95% EVOH1 | 95% EVOH1 | 95% EVOH1 | 95% EVOH1 | 95% EVOH1 |
| | 5% PA | 5% PA | 5% PA | 5% PA | 5% PA |
| | 6/12 (2.5) | 6/12 (2.5) | 6/12 (2.5) | 6/12 (2.5) | 6/12 (2.5) |
| layer 4 (E) | 100% LLDPE- | 100% LLDPE- | 100% LLDPE- | 100% LLDPE- | 100% LLDPE- |
| | md1 (1.8) | md1 (1.8) | md1 (1.8) | md1 (1.8) | md1 (1.8) |
| layer 5 (D) | 100% LLDPE2 | 100% LLDPE2 | 100% LLDPE2 | 100% LLDPE2 | 100% LLDPE2 |
| | (4.6) | (4.6) | (4.6) | (4.6) | (4.6) |
| layer 6 (E) | 100% LLDPE- | 100% LLDPE- | 100% LLDPE- | 100% LLDPE- | 100% LLDPE- |
| | md1 (1.5) | md1 (1.5) | md1 (1.5) | md1 (1.5) | md1 (1.5) |
| layer 7 (C) | 58% PET1 | 38% PET1 | 98% PET1 | 78% PET3 | 58% PET3 |
| | 40% PETG1 | 60% PETG1 | 2% PET1 | 20% PETG1 | 40% PETG1 |
| | 2% PET1 | 2% PET1 | MB (2.1) | 2% PET1 | 2% PET1 |
| | MB (2.1) | MB (2.1) | | MB (2.1) | MB (2.1) |
| Tot. Thickness | 21 | 21 | 21 | 21 | 21 |
| % Thickness | 22 | 22 | 22 | 22 | 22 |
| ratio layer 5 | | | | | |
| (D) | | | | | |

TABLE 4c
Films for Flowpack packaging applications

| | Ex. 25 | Ex. 26 | Ex. 27 | Ex. 28 | Ex. 29 |
|---|---|---|---|---|---|
| T annealing (° C.) | 60 | 60 | 60 | 60 | 60 |
| Annealing time (s) | 1.5 | 1.5 | 1.5 | 1.5 | 1.5 |
| Film width reduction (%) | 12% | 12% | 12% | 7 | 7 |
| T oven (° C.) | 108.5 | 108.5 | 109 | 110 | 112 |
| Stretching ratio LD, TD | 3.75 × 3.75 | 3.75 × 3.75 | 3.75 × 3.75 | 3.75 × 3.75 | 3.75 × 3.75 |
| Cross-linking KGy | 30 | 30 | 30 | 30 | 30 |
| layer 1 (B) | 75% LLDPE7 | 75% LLDPE7 | 75% LLDPE8 | 48% LLDPE6 | 38% LLDPE6 |
| | 25% LLDPE | 25% LLDPE | 25% LLDPE | 35% LLDPE4 | 17% LLDPE AF |
| | AF (7.1) | AF (7.1) | AF (7.1) | 17% LLDPE | 45% LLDPE4 |
| | | | | AF (7.0) | (7.0) |
| layer 2 (E) | 100% LLDPE- | 100% LLDPE- | 100% LLDPE- | 100% LLDPE- | 100% LLDPE- |
| | md1 (1.4) | md1 (1.4) | md1 (1.4) | md1 (1.7) | md1 (1.7) |
| layer 3 (A) | 95% EVOH1 | 95% EVOH1 | 95% EVOH1 | 95% EVOH1 | 95% EVOH1 |
| | 5% PA | 5% PA | 5% PA | 5% PA | 5% PA |
| | 6/12 (2.5) | 6/12 (2.5) | 6/12 (2.5) | 6/12 (2.4) | 6/12 (2.4) |
| layer 4 (E) | 100% LLDPE- | 100% LLDPE- | 100% LLDPE- | 100% LLDPE- | 100% LLDPE- |
| | md1 (1.8) | md1 (1.8) | md1 (1.8) | md1 (1.7) | md1 (1.7) |
| layer 5 (D) | 100% LLDPE2 | 100% LLDPE2 | 100% LLDPE2 | 100% LLDPE2 | 100% LLDPE9 |
| | (4.6) | (4.6) | (4.6) | (4.5) | (4.5) |
| layer 6 (E) | 100% LLDPE- | 100% LLDPE- | 100% LLDPE- | 100% LLDPE- | 100% LLDPE- |
| | md1 (1.5) | md1 (1.5) | md1 (1.5) | md1 (1.5) | md1 (1.5) |
| layer 7 (C) | 38% PET3 | 98% PET3 | 98% PETG1 | 98% PET1 | 58% PET3 |
| | 60% PETG1 | 2% PET1 | 2% PETG2 | 2% PET1 | 2% PET1 MB |
| | 2% PET1 | MB (2.1) | (2.1) | MB (2.1) | 40% PETG1 |
| | MB (2.1) | | | | (2.1) |
| Tot. Thickness | 21 | 21 | 21 | 21 | 21 |
| % Thickness | 22 | 22 | 22 | 21.5 | 21.5 |
| ratio layer 5 | | | | | |
| (D) | | | | | |

TABLE 5
Comparative Films for_Flowpack packaging applications

| | Comp. 1 | Comp. 2 | Ref. 1 |
|---|---|---|---|
| T annealing (° C.) | 75 | 75 | 75 |
| Annealing time (s) | 1.5 | 1.5 | 1.5 |
| Film width | 15 | 0% | 15 |
| reduction (%) | | | |
| T oven (° C.) | 105 | 112 | 113 |
| Stretching ratio | 4.3 × 3.75 | 3.75 × 3.75 | 3.75 × 3.75 |
| LD, TD | | | |
| layer 1 (B) | 37.5% VLDPE1 | 83% LLDPE1 | 75% LLDPE1 |
| | 37.5% LLDPE1 | 17% LLDPE | 25% LLDPE |
| | 25% LLDPE | AF (7.2) | AF (7.1) |
| | AF (5.0) | | |
| layer 2 | 100% EVA1 | 100% LLDPE- | 100% LLDPE- |
| | (7.0) (D) | md1 (1.4) | md1 (2.2) |
| layer 3 | 100% LLDPE- | 95% EVOH1 | 95% EVOH1 |
| | md1 (2.0) | 5% PA | 5% PA |
| | | 6/12 (2.5) | 6/12 (2.5) |
| layer 4 | 95% EVOH1 | 100% LLDPE- | 100% |
| | 5% PA | md1 (1.8) | LLDPE- |
| | 6/12 (2.5) | | md1 (2.2) |
| layer 5 | 100% EMA- | 100% EMAA1 | 75% LLDPE1 |
| | md1 (3.0) | (4.7) (D) | 25% LLDPE |
| | | | AF (7.1) |
| layer 6 | 70% PET1 | 100% LLDPE- | — |
| | 30% PETG1 | md1 (1.5) | |
| | (1.5) | | |
| layer 7 | — | 98% PET1 | |
| | | 2% PET1 | |
| | | MB (2.2) | |
| Tot. Thickness | 21 | 21.3 | 21.1 |
| % Thickness | — | 22 | — |
| ratio layer 5 | | | |
| (D) | | | |

Reference film 1 is a film currently marketed for Flowpack packaging applications.

TABLE 6a
Films for_tray-lidding packaging applications

| | Ex. 12 | Ex. 13 | Ex. 14 |
|---|---|---|---|
| T annealing (° C.) | 90 | 90 | 90 |
| Annealing time (s) | 1.4 | 1.4 | 1.4 |
| Film width | 19% | 17% | 19% |
| reduction (%) | | | |
| T oven (° C.) | 113 | 113 | 110.5 |
| Stretching ratio | 3.75 × 3.75 | 3.75 × 3.75 | 3.75 × 3.5 |
| LD, TD | | | |
| layer 1 (B) | 35% EPC1 | 35% EPC2 | 35% EPC3 |
| | 15% OBC1 | 48% LLDPE1 | 48% LLDPE1 |
| | 33% LLDPE1 | 17% LLDPE | 17% LLDPE |
| | 17% LLDPE | AF (9.4) | AF (9.4) |
| | AF (9.4) | | |
| layer 2 (E) | 100% LLDPE- | 100% LLDPE- | 100% LLDPE- |
| | md1 (1.4) | md1 (1.4) | md1 (1.8) |
| layer 3 (A) | 95% EVOH1 | 95% EVOH1 | 95% EVOH1 |
| | 5% PA | 5% PA | 5% PA |
| | 6/12 (2.5) | 6/12 (2.5) | 6/12 (2.5) |
| layer 4 (E) | 100% LLDPE- | 100% LLDPE- | 100% LLDPE- |
| | md1 (1.8) | md1 (1.8) | md1 (1.8) |
| layer 5 (D) | 100% LLDPE2 | 100% LLDPE2 | 100% LLDPE2 |
| | (4.7) | (4.7) | (10.8) |
| layer 6 (E) | 100% LLDPE- | 100% LLDPE- | 100% LLDPE- |
| | md1 (1.5) | md1 (1.5) | md1 (1.6) |
| layer 7 (C) | 98% PET1 | 98% PET1 | 98% PET1 |
| | 2% PET1 | 2% PET1 | 2% PET1 |
| | MB (2.2) | MB (2.2) | MB (2.2) |
| Tot. Thickness | 23.5 | 23.5 | 30.0 |
| % Thickness | 20 | 20 | 36 |
| ratio layer 5 | | | |
| (D) | | | |

TABLE 6b
Films for tray-lidding packaging applications

| | Ex. 15 | Ex. 16 | Ex. 17 | Ex. 18 |
|---|---|---|---|---|
| T annealing (° C.) | 90 | 90 | 90 | 90 |
| Annealing time (s) | 1.5 | 1.5 | 1.5 | 1.5 |
| Film width reduction (%) | 16% | 16% | 16% | 19% |
| T oven (° C.) | 115 | 115 | 115 | 115 |
| Stretching ratio LD, TD | 3.75 × 3.75 | 3.75 × 3.75 | 3.75 × 3.75 | 3.75 × 3.75 |
| layer 1 (B) | 30% PP | 21% PP | 21% PP | 21% PP |
| | 16% EPC3 | 25% EPC3 | 25% EPC3 | 25% EPC3 |
| | 54% LLDPE7 | 54% LLDPE7 | 54% LLDPE6 | 54% LLDPE1 |
| | (8.5) | (8.5) | (9.8) | (9.8) |
| layer 2 (E) | 100% LLDPE- | 100% LLDPE- | 100% LLDPE- | 100% LLDPE- |
| | md3 (1.9) | md1 (1.9) | md1 (1.9) | md1 (1.9) |
| layer 3 (A) | 95% EVOH1 | 95% EVOH1 | 95% EVOH1 | 95% EVOH1 |
| | 5% PA | 5% PA | 5% PA | 5% PA |
| | 6/12 (2.6) | 6/12 (2.6) | 6/12 (2.7) | 6/12 (2.7) |
| layer 4 (E) | 100% LLDPE- | 100% LLDPE- | 100% LLDPE- | 100% LLDPE- |
| | md3 (1.9) | md1 (1.9) | md1 (1.9) | md1 (1.9) |
| layer 5 (D) | 100% LLDPE2 | 100% LLDPE2 | 100% LLDPE2 | 100% LLDPE2 |
| | (3.8) | (4.7) | (4.1) | (4.7) |
| layer 6 (E) | 100% EMA- | 100% LLDPE- | 100% LLDPE- | 100% LLDPE- |
| | md1 (1.7) | md1 (1.7) | md1 (1.7) | md1 (1.7) |
| layer 7 (C) | 98% PET1 | 98% PET1 | 98% PET1 | 98% PET1 |
| | 2% PET1 | 2% PET1 | 2% PET1 | 2% PET1 |
| | MB (4.6) | MB (3.7) | MB (3.0) | MB (2.3) |
| Tot. Thickness | 25 | 25 | 25 | 25 |
| % Thickness | 15 | 19 | 16 | 19 |
| ratio layer 5 | | | | |
| (D) | | | | |

TABLE 7
Comparative Films for tray-lidding applications

| | Comp. 3 | Comp. 4 | Comp. 5 | Comp. 6 |
|---|---|---|---|---|
| T annealing (° C.) | 90 | 90 | 90 | 90 |
| Annealing time (s) | 1.4 | 1.4 | 1.4 | 1.4 |
| Film width reduction (%) | 19 | 19 | 16 | 17 |
| T oven (° C.) | 110.5 | 111 | 115 | 115 |
| Stretching ratio LD, TD | 3.75 × 3.5 | 3.75 × 3.5 | 3.75 × 3.75 | 3.75 × 3.72 |
| layer 1 (B) | 35% EPC3 | 35% EPC3 | 35% EPC3 | 35% EPC3 |
| | 48% LLDPE1 | 48% LLDPE1 | 48% LLDPE1 | 48% LLDPE1 |
| | 17% LLDPE | 17% LLDPE | 17% LLDPE | 17% LLDPE |
| | AF (9.4) | AF (4.2) | AF (9.4) | AF (9.4) |
| layer 2 (E) | 100% LLDPE- | 100% LLDPE- | 100% LLDPE- | 100% LLDPE- |
| | md1 (1.8) | md1 (0.8) | md1 (1.8) | md1 (1.8) |
| layer 3 (A) | 95% EVOH1 | 95% EVOH1 | 100% LLDPE2 | 95% EVOH1 |
| | 5% PA | 5% PA | (2.5) | 5% PA |
| | 6/12 (2.5) | 6/12 (1.2) | | 6/12 (2.5) |
| layer 4 (E) | 100% LLDPE- | 100% LLDPE- | 100% LLDPE- | 100% LLDPE- |
| | md1 (1.8) | md1 (0.8) | md1 (1.8) | md1 (1.8) |
| layer 5 (D) | 100% LLDPE2 | 100% LLDPE2 | 100% LLDPE2 | 100% LLDPE- |
| | (2.2) | (10.8) | (4.7) | md1 (4.7) |
| layer 6 (E) | 100% LLDPE- | 100% LLDPE- | 100% LLDPE- | 100% LLDPE- |
| | md1 (1.6) | md1 (0.7) | md1 (1.6) | md1 (1.6) |
| layer 7 (C) | 98% PET1 | 98% PET1 | 98% PET1 | 98% PET1 |
| | 2% PET1 | 2% PET1 | 2% PET1 | 2% PET1 |
| | MB (2.2) | MB (1) | MB (2.2) | MB (2.2) |
| Tot. Thickness | 21.5 | 19.5 | 24 | 24 |
| % Thickness | 10 | 55 | 20 | 20 |
| ratio layer 5 | | | | |
| (D) | | | | |

The films according to the invention and the comparative films were evaluated according to the test methods previously described or detailed below. The measured properties of the films or of the packages so obtained are collected in the following Tables 8 to 14 and 16.

TABLE 8
properties of films for HFFS applications

| | | Ex. 1 | Ex. 3 | Ex. 4 | Ex. 5 | Ex. 7 | Ex. 8 |
|---|---|---|---|---|---|---|---|
| Max shrink tension | LD | 23.1 | | 34.6 | 27.9 | 36.5 | 25.8 |
| (Kg/cm²). ramp 180° C. | TD | 38.9 | | 17 | 26.1 | 21 | 25.3 |
| Residual shrink at 5° C. | LD | 26.80 | | 32.0 | 33.5 | 34.4 | 31.0 |
| (Kg/cm²) ramp 180° C. | TD | 28.3 | | 27.6 | 31.2 | 30.1 | 29.8 |
| Free shrink (%) at 85° C. | LD | 14 | 16 | 20 | 15 | 15 | 18 |
| water | TD | 21 | 12 | 11 | 15 | 15 | 15 |
| Antifog score | 1 hr | 4.5 | | | | 4 | 4 |
| (sealant vs. beaker) | 24 hrs | 5 | | | | 5 | 4 |
| Haze (%) | | 3.9 | | 3.9 | 3.8 | 4.5 | 3.7 |
| Gloss at 60° (G.U.) | | 146 | | 147 | 146 | 140 | 144 |
| Modulus (Kg/cm²) | LD | 10300 | | | 10300 | 11700 | 10500 |
| | TD | 11600 | | | 8900 | 9000 | 8900 |
| Tensile (Kg/cm²) | LD | 1040 | | | 990 | 1040 | 950 |
| | TD | 1200 | | | 990 | 780 | 890 |
| Elongation (%) | LD | 80 | | | 80 | 70 | 80 |
| | TD | 80 | | | 90 | 90 | 90 |
| Curling (%) | LD | | 0 | | 15 | | |
| | TD | | 0 | | 0 | | |
| Gel content (%) | | | | | | | 9.6 |
| layers 1 and 2 | | | | | | | |

TABLE 9a
properties of films for HFFS applications

| | | | | | | Comp. |
|---|---|---|---|---|---|---|
| | | Ex. 9 | Ex. 10 | Ex. 11 | Ref. 1 | 1 |
| Max shrink tension | LD | 33.1 | 38.7 | 32.4 | 30 | 25.8 |
| (Kg/cm²). ramp | TD | 30.0 | 22.1 | 27.6 | 15 | 22.9 |
| 180° C. | | | | | | |
| Residual shrink at | LD | 34.9 | 37.9 | 30.4 | 27.1 | 23.6 |
| 5° C. (Kg/cm²) | TD | 30.5 | 31.2 | 30.0 | 22.7 | 24.2 |
| ramp 180° C. | | | | | | |
| Free shrink (%) at | LD | 20 | 20 | 14 | 11 | 25 |
| 85° C. water | TD | 24 | 8 | 13 | 3 | 20 |
| Haze (%) | | 4.5 | 4.8 | 4.1 | 7.6 | 3.5 |
| Gloss at 60° (G.U.) | | 147 | 143 | 141 | 110.6 | 141 |
| Haze after Flowpack | | 6.6 | 6.4 | | 7.1 | |
| cycle (%) | | | | | | |
| Gloss at 60° after | | 123 | 140 | | 116 | |
| Flowpack cycle | | | | | | |
| (G.U.) | | | | | | |
| Modulus (Kg/cm²) | LD | 9100 | 9600 | 10200 | 6800 | 7680 |
| | TD | 8400 | 6900 | 9100 | 6200 | 6800 |
| Tensile (Kg/cm²) | LD | 1000 | 1000 | 1000 | 1100 | 890 |
| | TD | 800 | 700 | 800 | 850 | 650 |
| Elongation (%) | LD | 90 | 90 | 80 | 110 | 69 |
| | TD | 100 | 120 | 90 | 170 | 64 |
| Curling (%) | LD | | | | | 100 |
| | TD | | | | | 0 |

TABLE 9b
properties of films for HFFS applications

| | | Ex. 19 | Ex. 20 | Ex. 21 | Ex. 22 |
|---|---|---|---|---|---|
| Free shrink (%) at | LD | 11 | 11 | 15 | 10 |
| 85° C. water | TD | 20 | 19 | 22 | 18 |
| Haze (%) | | 5.7 | 5.2 | 6.3 | 5.7 |
| Gloss at 60° (G.U.) | | 137 | 138 | 130 | 127 |
| Modulus (Kg/cm²) | LD | 8670 | 7990 | 7990 | 8260 |
| | TD | 8530 | 8150 | 8150 | 8750 |
| Tensile (Kg/cm²) | LD | 922 | 996 | 875 | 896 |
| | TD | 683 | 912 | 910 | 901 |
| Elongation (%) | LD | 88 | 89 | 83 | 84 |
| | TD | 110 | 99 | 79 | 93 |

TABLE 9c
properties of films for HFFS applications

| | | Ex. 23 | Ex. 24 | Ex. 25 | Ex. 26 |
|---|---|---|---|---|---|
| Free shrink (%) at | LD | 16 | 16 | 14 | 12 |
| 85° C. water | TD | 20 | 20 | 19 | 22 |
| Haze (%) | | 6.2 | 5.8 | 5.5 | 6.1 |
| Gloss at 60° (G.U.) | | 132 | 136 | 131 | 136 |
| Modulus (Kg/cm²) | LD | 7570 | 9270 | 7270 | 9610 |
| | TD | 7320 | 7900 | 6500 | 8810 |
| Tensile (Kg/cm²) | LD | 887 | 1090 | 933 | 1030 |
| | TD | 860 | 901 | 763 | 926 |
| Elongation (%) | LD | 100 | 85 | 93 | 89 |
| | TD | 110 | 93 | 100 | 92 |

As clearly shown in Tables 8 and 9a to 9C, the films of the present invention are characterized by good optical and mechanical properties. In particular, mechanical and optical properties resulted better than Reference film 1 and Comparative film 1 wherein, in this last one, layer (D) is positioned on the other side of the barrier layer (A), namely between the barrier layer (A) and sealant layer (B), according to prior art. Furthermore, the present films keep good optics (haze and gloss) even after shrink, namely even after having been subjected to a Flowpack cycle as previously described. The good free shrink values at 85° C. of the films of Ex. 9 and 10 provide for very tight packages and, especially for Example 9, reduce the occurrence of “dog ears” i.e. the peripheral portion of the film that remain unshrunk around the product after the shrink. Dog ears are quite unpleasant and can discourage the final consumer from buying the package for a number of reasons: they ruin the pack appearance, also because whiter than the shrunk film, they are perceived as wasted material thus giving the impression of a package having lower sustainability and finally they are really unpleasant at touch when handling the package.

Moreover, the ranges of maximum shrink tensions and residual shrink tension values of the films of the present invention allow obtaining tight packages, as confirmed by visually inspecting the packages with the dummies.

The film of Comparative 1 showed, on the contrary, too low values of residual shrink tensions to get well-tensioned packages. Furthermore, the film of Comparative 1 was completely curled.

Curling values in LD and TD of the films of the present invention are lower than those of the Comparative film of Example 1, thus resulting in a more easy-to-handle material. Curling is likely to occur in asymmetric films as the ones of the present invention. It appears that low curling was mainly due to the position and thickness ratio in percentage of layer D, which unexpectedly was able to balance the structure.

Surprisingly, the antifog score values for the films of the present invention are very high. This was unexpected as it is known that usually a migration of the antifog agents towards the skin layer occurs during the storage of the roll thus worsening the antifog performance, especially considering the chemical affinity between the antifog agents and the polyester resin of the outer layer. In addition, in the films of the present invention, the antifog agent is only present in the sealant layer and in lower amount compared to Ref.1 film, wherein the same antifog masterbatch is used but in higher amount and not only in the sealant layer but also in the outer layer.

### Flowpack Packaging of Cheese

Flowvac packaging tests on grana and parmesan chunks (300 g each of dimensions 150-170 mm×80 mm×60 mm Length×Height×Width see FIGS. 4 and 5) were performed with the films of Ex.8 and Ex.7 with very good results, comparable with those obtained with wood dummies.

The packaging cycle was done on a HFFS machine ULMA NEVADA, equipped with a shrink tunnel CJ 51 (tunnel temperatures: 135°/160°/165° C.). 150 packages for each film were manufactured. In this packaging process, the particular shape of the product entails that there is exceeding film in the final package. In this respect, we observed that the packages manufactured from the film of Ex. 8 showed a slight whitening around the exceeding sealed material while the packages made from film of Ex. 7 were perfectly clear (see FIG. 6 pictures of similar packages with wood dummies).

TABLE 10a
properties of films for tray lidding

| | | Ex. 12 | Ex. 13 | Ex. 14 | Comp. 3 | Comp. 4 | Comp. 5 | Comp. 6 |
|---|---|---|---|---|---|---|---|---|
| Max shrink tension | LD | 21.3 | 21.3 | 24.7 | 21.2 | 31.3 | 23.7 | 16.9 |
| (Kg/cm²), ramp 180° C. | TD | 14.9 | 14.5 | 13.1 | 10.0 | 12.7 | 14.0 | 12.1 |
| Residual shrink at 5° C. | LD | 29.0 | 28.8 | 26.9 | 33.1 | 27.7 | 29.4 | 26.6 |
| (Kg/cm²), ramp 180° C. | TD | 31.0 | 30.7 | 27.4 | 24.7 | 31.1 | 30.0 | 25.6 |
| Shrink tension (Kg/cm²) at | LD | 18.7 | 18.7 | 23.4 | 20.0 | 29.2 | 21.8 | 15.8 |
| 85° c., ramp 105° C. | TD | 7.7 | 9.9 | 5.6 | 4.9 | 2.0 | 6.3 | 8.3 |
| Shrink tension (Kg/cm²) at | LD | 21.5 | 16.5 | | | | | |
| 95° c., ramp 105° C. | TD | 10.7 | 11.3 | | | | | |
| Shrink tension (Kg/cm²) at | LD | 22.0 | 17.2 | | | | | |
| 105° c., ramp 105° C. | TD | 11.8 | 12.9 | | | | | |
| Residual shrink at 5° C. | LD | 26.0 | 22.4 | | | | | |
| (Kg/cm²), ramp 105° C. | | | | | | | | |
| Free shrink (%) at 85° C., | LD | 10 | 10 | 13 | 15 | 13 | 14 | 13 |
| water | TD | 6 | 5 | 5 | 5 | 0 | 5 | 9 |
| Free shrink (%) at 85° C., oil | LD | 11 | 6 | | | | | |
| | TD | 6 | 4 | | | | | |
| Free shrink (%) at 95° C., oil | LD | 19 | 14 | | | | | |
| | TD | 11 | 11 | | | | | |
| Free shrink (%) at 105° C., | LD | 28 | 24 | | | | | |
| oil | TD | 22 | 24 | | | | | |
| Gel content (%) layers 1 | | 8.5 | | | | | | |
| and 2 | | | | | | | | |
| Haze (%) | | 5.3 | 5.3 | | | | | |
| Gloss at 60° (G.U.) | | 130 | 131 | | | | | |
| Modulus (Kg/cm²) | LD | 9430 | 9710 | 7540 | 10900 | | | |
| | TD | 8000 | 8140 | 6030 | 8600 | | | |
| Tensile (Kg/cm²) | LD | 1020 | 1030 | 1030 | 1030 | | | |
| | TD | 830 | 810 | 760 | 870 | | | |
| Elongation (%) | LD | 100 | 100 | 110 | 85 | | | |
| | TD | 130 | 130 | 160 | 120 | | | |
| Curling (%) | LD | 7.3 | 9.2 | 8.0 | 9.6 | 98.0 | 72.0 | 36.0 |
| | TD | 0 | 0 | 51 | 100 | 100 | 100 | 58 |

TABLE 10b
properties of films for tray lidding

| | | Ex. 15 | Ex. 16 | Ex. 17 | Ex. 18 |
|---|---|---|---|---|---|
| Shrink tension (Kg/cm²) at | LD | 15.2 | 22.1 | 16.9 | n.a. |
| 85° C., ramp 105° C. | TD | 15 | 11.2 | 10.2 | n.a. |
| Shrink tension (Kg/cm²) at | LD | 16 | 21.8 | 17.1 | n.a. |
| 105° C., ramp 105° C. | TD | 14.1 | 15.8 | 13.2 | n.a. |
| Residual shrink at 5° C. | LD | 179 | 174 | 151 | n.a. |
| (Kg/cm²), | TD | 173 | 235 | 199 | n.a. |
| ramp 105° C. | | | | | |
| Free shrink (%) at | LD | 7 | 6 | 5 | 11 |
| 85° C., water | TD | 7 | 5 | 2 | 7 |
| Free shrink (%) at | LD | 15 | 12 | 13 | 17 |
| 95° C., oil | TD | 15 | 11 | 11 | 14 |
| Free shrink (%) at | LD | 23 | 23 | 24 | 27 |
| 105° C., oil | TD | 22 | 23 | 23 | 26 |
| Haze (%) | | 4 | n.a. | 4.5 | n.a. |
| Gloss at 60° (G.U.) | | 138 | n.a. | 129 | n.a. |
| OTR (23° C., 0% RH, 1 atm) | | 17 | n.a. | n.a. | n.a. |
| Thermal & Cutting damage | % rejects | 25% | 34% | 67% | — |
| | Defective | 30 | 41 | 80 | — |
| | packages | | | | |
| | N. packages | 120 | 120 | 120 | — |
| | tested | | | | |
| Modulus (Kg/cm²) | LD | 14335 | n.a. | 9690 | 9730 |
| | TD | 14400 | n.a. | 8190 | 7790 |
| Tensile (Kg/cm²) | LD | 1143 | n.a. | 900 | 930 |
| | TD | 807 | n.a. | 730 | 770 |
| Elongation (%) | LD | 83 | n.a. | 95 | 85 |
| | TD | 125 | n.a. | 130 | 130 |
| Curling (%) | LD | 0.3 | n.a. | n.a. | n.a. |
| | TD | n.a. | n.a. | n.a. | n.a. |

n.a. not assessed

According to the data reported in Tables 10a and 10b it appears that the films of the invention (see in particular Ex. 12, 13 and 15) show low curling values which are highly desirable for realizing tray lidding hermetic seals. A quite specific thickness ratio of layer (D) seems of relevance as value lower (see Comparative film 3, ratio 10%) or higher (see Comparative film 4—55%) than those presently claimed resulted in very unbalanced structures with curling values unacceptable for tray lidding.

Furthermore, Comparative film 5 shows that replacing the barrier layer with a LLDPE based layer significantly worsen the curling (see the curling in comparison with the film of example 12).

Finally, the film of Comparative example 6 demonstrates the relevance of the composition of layer (D): in fact, if layer (D) is composed of 100% of modified polyolefins the structure appears unbalanced and the curling effect increased (see curling of Comparative example 6 vs curling of Example 12).

The films of the invention are further characterized by good residual shrink tension values, which provide for packages with tight lids even after storage at 5° C.

TABLE 11
Flowpack Packaging Test

| | Machine | % of packages | | | |
|---|---|---|---|---|---|
| | speed | with | with | with | other |
| Films: | (ppm) | no leaks | T leaks | L leaks | defects |
| Ref. 1 | 50 | 94% | 6% | | |
| Ex. 1 | 50 | 91% | 8% | 1% | |
| Ex. 2 | 50 | 93% | 4% | 1% | 2% |
| Ex. 3 | 50 | 99% | 1% | 0% | |
| Ex. 4 | 50 | 90% | 5% | 5% | |
| Ex. 5 | 50 | 94% | 4% | 2% | |
| Comp. 2 | 50 | 80% | 19% | 1% | |
| Ex. 6 | 50 | 91% | 1% | 7% | 1% |
| Ex. 7 | 50 | 98% | 2% | 0% | |
| Ex. 8 | 50 | 100% | 0% | 0% | |
| Ex. 9 | 50 | 88% | 9% | 3% | |
| Ex. 10 | 50 | 97% | 3% | | |
| Ex. 11 | 50 | 97% | 3% | | |
| Ref. 1 | 70 | 92% | 6% | | 2% |
| Ex. 1 | 70 | 84% | 12% | 2% | 2% |
| Ex. 2 | 70 | 92% | 8% | | |
| Ex. 3 | 70 | 88% | 8% | 2% | 2% |
| Ex. 5 | 70 | 96% | 2% | 2% | |
| Ex. 7 | 70 | 88% | 8% | | 4% |
| Ex. 8 | 70 | 100% | | | |

The film of the present invention, when run on an Ilapack machine according to the protocol hereinbefore described and tested for the rejects, resulted very reliable in terms of sealability, hermeticity and resistance to perforation. As shown in Table 11, the percentage of rejects at 50 ppm was in most of the cases very low.

The films of the Examples 1 to 3 and 5 to 7, all having the same resins and thickness of the sealant layer compared with the film of Comparative 2, showed lower % of rejects when running at 50 ppm. It appears that the worse performance of Comparative film 2 (20% of rejects vs 0-9% of the present films) might be partially due to the different composition of layer (D) that consists of a methacrylate instead of a LLDPE. A slight modification of the seal layer composition provides for the best result (no rejects, see the film of Ex. 8)

Even more surprisingly, such a good performance was in some cases maintained (Ex.8) or even improved (Ex.5) at 70 ppm, which is a very high and demanding machine speed. It thus appears that advantageously the films of the present invention allow increasing the machine speed, thus increasing productivity and reducing costs.

### Hermeticity and Pack Appearance in Tray Lidding Applications

TABLE 12
hermeticity of tray lidded packages

| | | | | Hermeticity: | |
|---|---|---|---|---|---|
| | | Sealing | Sealing | average | |
| | Tray: | temperature | time | pressure | Contam- |
| Film | monoPP | (° C.) | (seconds) | (bar) | ination |
| Ex. 12 | ESPlastic | 165 | 0.5 | 0.45 | no |
| Ex. 12 | ESPlastic | 165 | 0.5 | 0.42 | yes |
| Ex. 13 | ESPlastic | 165 | 0.5 | 0.45 | no |
| Ex. 13 | ESPlastic | 165 | 0.5 | 0.42 | yes |

TABLE 13
hermeticity of tray lidded packages

| | | | Sealing | Sealing | Hermeticity: | |
|---|---|---|---|---|---|---|
| | | Seal | temperature | time | average pressure | |
| Film | Tray | bars | (° C.) | (seconds) | (bar) | Contamination |
| Ex. 12 | Cryovac PP-PE | Flat 4 mm | 130 | 0.5 | 0.45 | yes |
| | 1826-37 | | | | | |
| Ex. 12 | Cryovac PP-PE | Convex | 130 | 0.5 | 0.42 | yes |
| | 1826-37 | | | | | |

TABLE 14
pack appearance of tray lidded packages

| | | Tray | | Flange | | Pack | |
|---|---|---|---|---|---|---|---|
| | | distortion | | deformation | | relaxation | |
| | | (%) | | (score) | | (score) | |
| Film | Tray: mono PP | 0 h | 24 h | 0 h | 24 h | 0 h | 24 h |
| Ex. 12 | Faerch | 0 | 0 | 0 | 0 | 4 | 4 |
| Ex. 12 | ESPlastic | 3.1 | 2.7 | 0.1 | 0.1 | 3.6 | 3.1 |
| Ex. 13 | Faerch | 0 | 0 | 0 | 0 | 4 | 4 |
| Ex. 13 | ESPlastic | 3.1 | 3 | 0.2 | 0.2 | 3.8 | 3.3 |

Tables 12, 13 and 14 showed the evaluation of hermeticity and pack appearance of packages manufactured by tray lidding, as previously described in the hermeticity test.

The films of the present invention allowed obtaining highly hermetic packages as clearly demonstrated by the pressure value of the hermeticity test in Table 12 and 13. Such pressure values exceeded the threshold values of 0.40 and 0.35 bar respectively for clean and contaminated sealing conditions.

The films of the present invention allowed setting the sealing temperature at 165° C. still guaranteeing good hermeticity. Setting low sealing temperature has the advantage of reducing the tray deformation in case of soft and thin tray as ESPlastic tray used in the evaluation, but on the other side pack relaxation is more likely to occur. This was not the case, as the films of the present invention, endowed with tailored shrink properties, provided very tight packages, with almost no occurrence of pleats even after 24 hours in the fridge at 4° C. (pack relaxation score between 3 and 4, Table 14). The packages remained tight, as also demonstrated by the drum-sound emitted when beaten, the tray was substantially not distorted (tray distortion score lower than 4%, maximum 3% after 24 hours in the fridge at 4° C., Table 14) and the flange was not deformed (flange deformation values closed to 0, Table 14), thus resulting in a superior pack appearance compared to the films on the market. Such high performance after packaging was especially unexpected for the weakest tray used for the evaluation (ESPlastic).

### Comparative Film for Shrink Bags Applications

The comparative film 7 was manufactured according to the description of Example 1 of WO2015/107127A1. This film is characterized by the presence of two layers (D) positioned on opposite sides with respect to the barrier layer (A):

TABLE 15
Film for_shrinkable bags

| | Comp. 7 |
|---|---|
| T annealing (° C.) | 40 |
| Annealing time (s) | 2 |
| T bath (° C.) | 94 |
| Stretching ratio LD, TD | 3.4 × 3.4 |
| layer 1 (B) | 80% VLDPE2 |
| | 20% VLDPE1 (7.8) |
| layer 2 (D) | 80% EA01 |
| | 20% LLDPE5 (8.8) |
| layer 3 (E) | 100% EVA2 (3.9) |
| layer 4 (A) | 100% PVDC-MA (5.4) |
| layer 5 (E) | 100% EVA2 (3.9) |
| layer 6 (D) | 100% EA01 (7.8) |
| layer 7 (E) | 100% LLDPE- md2 (4.9) |
| layer 8 (C) | 100% PET2 |
| Tot. Thickness (mic) | 60 |
| % Thickness ratio layer 6 (D) | 13% |

The shrinking properties of Comparative 7 film were evaluated according to the methods previously described:

TABLE 16
properties of comparative film for shrinkable bags

| | | Comp. 7 |
|---|---|---|
| Max shrink tension | LD | 33 |
| (Kg/cm²) ramp 180° C. | TD | 43 |
| Residual shrink at 5° C. | LD | 31 |
| (Kg/cm²) ramp 180° C. | TD | 40 |
| Free shrink (%) at 85° C. | LD | 40 |
| water | TD | 21 |
| Antifog score (sealant | 1 hr | 4.5 |
| vs. beaker) | 6 hrs | 5 |

As can be seen from Table 16, the Comparative film 7 even if endowed with an acceptable residual shrink tension, had too high values of max and free shrink tensions, which are not optimal for tray lidding applications. Furthermore, Comparative film 7 showed a curling that allowed its use in shrinkable bags but that was not ideal for tray lidding applications.

In conclusion, the films of the present invention are endowed with optimal shrink properties, good processability at extrusion, orientation and annealing level, and very good optical (also after shrink) and mechanical properties. They are surprisingly well balanced, thanks to the inner layer D position, thickness and composition, thus showing low curling values and being highly manageable especially in tray lidding applications.

The asymmetric layer sequence developed by the Applicant allows obtaining tailored shrink properties and stable processes. The film structure is suitable for manufacturing films for Flowpack, films for tray lidding packaging and films for shrinkable bags by tailoring the shrink properties to the rigidity of the container (influenced by the material, the design and the depth of the container) or to the rigidity of the product to be packaged, by modifying the manufacturing conditions of the films as herein described. The films of the present invention resulted sealable onto mono-PP trays at advantageously low temperatures.

The films are useful for tray lidding, “Flowpack” and bags applications and are able to guarantee very good package hermeticity and pack appearance.

Finally, with the film according to the present invention, faster HFFS machine cycle may be used as the films showed superior sealing, machinability and shrink performance.

By the process according to the second object of the present invention, it is possible to impart to the film proper shrink properties, which are customizable on the rigidity/softness and the design of the container or of the wrapped products. This accurate balance of shrink properties prevents package relaxation during its storage in cold conditions and allows maintaining its tight appearance without incurring in excessive tray or product distortion.

1. A multilayer asymmetrical heat-shrinkable gas-barrier thermoplastic packaging film comprising
an outer sealant layer (B),
an inner gas-barrier layer (A),
an outer layer (C) comprising a major proportion of polyester(s),
at least an inner layer (D), positioned between the gas barrier layer (A) and the outer layer (C), comprising a major proportion of polyolefin(s) and/or of ethylene-vinyl acetate copolymer(s),
no inner layer comprising a major proportion of polyamide(s) or polyester(s),
no inner layer positioned between the gas barrier layer (A) and the sealant layer (B) comprising a major proportion of polyolefin(s),
wherein the thickness ratio in percentage of the inner layer (D) with respect to the total thickness of the film is from 15 to 50% and the total thickness of the film is lower than 80 microns.

2. (canceled)

3. The film according to claim 2 comprising
no inner layer comprising polyamide(s) or polyester(s), and
no inner layer positioned between the gas barrier layer (A) and the sealant layer (B) comprising polyolefin(s).

4. The film according to claim 1, wherein the thickness ratio in percentage of the inner layer (D) with respect to the total thickness of the film is from 15 to 35%.

5. The film according to claim 1 wherein:
the sealant layer (B) comprises one or more resins selected among polyolefins, modified polyolefins and their blends; and/or
the barrier layer (A) comprises at least an EVOH resin, in amount of at least 70% by weight with respect to the layer weight; and/or
the outer layer (C) comprises a major proportion of aromatic polyesters; and/or
the inner layer (D) comprises a resin selected from ethylene homopolymers, ethylene-alpha-olefin copolymers ethylene-vinyl acetate copolymers, polypropylene homopolymers, propylene-ethylene co-polymers, propylene-ethylene-butene copolymers, propylene-butene-ethylene copolymers and their blends.

6. The film according to claim 1 wherein layer (B) and/or layer (D) comprise a major proportion of a LLDPE.

7. The film according to claim 1 wherein the outer polyester layer (C) comprises a blend of polyesters comprising one or more PETG(s) in amount from 30% to 50% by weight with respect to the weight of the polyester blend.

8. The film according to claim 1 wherein
the sealant layer (B) comprises polyolefins or their blends in major proportion, in amount higher than 60% by weight with respect to layer (B) weight; and/or
the outer layer (C) comprises polyester(s) in amount higher than 60% by weight with respect to layer (C) weight.

9. The film according to claim 1 wherein the thickness ratio in percentage of
the sealant layer (B) is at most 45%; and/or
the barrier layer (A) is from 4% to 30%; and/or
the outer layer (C) is from 3% to 25%; and/or
the inner layer (D) is from 15% to 35%,
with respect to the total thickness of the film.

10. The film according to claim 1 further comprising at least a tie layer (E), wherein the tie layer (E) has a thickness ratio in percentage lower than 15% with respect to the total thickness of the film.

11. The film according to claim 1 wherein the sequence of layers is selected among B/A/D/C, B/A/D/E/C, B/E/A/D/C, B/E/A/D/E/C, B/E/A/E/D/E/C, B/F/A/D/C, B/F/A/D/E/C, B/F/E/A/D/C, B/F/E/A/D/E/C and B/F/E/A/E/D/E/C.

12. The film according to claim 1, obtainable according to the process of claim 15, said film being characterized by
a haze value between 1% and 15% measured according to standard ASTM D 1003; and/or
a gloss value (60° angle) higher than 100 g.u., measured according to standard ASTM D 2457.

13. The film according to claim 1 suitable for Flowpack packaging applications, characterized by
a maximum shrink tension, measured according to the test method herein reported, lower than 45 kg/cm² both in the longitudinal and transverse directions and/or higher than 15 kg/cm² both in the longitudinal and transverse directions; and/or
a residual shrink tension at 5° C., measured according to the test method herein reported, lower than 45 Kg/cm² both in the longitudinal and transverse directions and/or higher than 25 Kg/cm²; and/or
a free shrink in the longitudinal direction, measured at 85° C. in water according to ASTM D 2732, higher than 5%, and/or lower than 30%; and/or
a free shrink in the transverse direction, measured at 85° C. in water according to ASTM D 2732, higher than 5% and/or lower than 30%; and/or
a difference between the free shrink values in the longitudinal direction and transverse directions, measured at 85° C. in water according to ASTM D 2732, lower than 15%; and/or
an elastic modulus, measured according to ASTM D 882, in the range 8000 to 14000 kg/cm² in each of the longitudinal and transverse directions; and/or
an elongation at break, measured according to ASTM D882, in the range 70 to 140% in each of the longitudinal and transverse directions; and/or
a tensile at break, measured according to ASTM D882, in the range 700 to 1200 kg/cm² in each of the longitudinal and transverse directions; and/or
a curling, measured according to the test method herein reported, not higher than 20% in each one of the longitudinal and transverse directions and/or not higher than 10% in the transverse direction,
wherein said film is obtainable according to the process of claim 16.

14. The film according to claim 1 suitable for tray lidding packaging applications, characterized by:
a maximum shrink tension, measured according to the test method herein reported, lower than 25 kg/cm² both in the longitudinal and transverse directions and/or higher than 7 kg/cm² both in the longitudinal and transverse directions; and/or
a residual shrink tension at 5° C., measured according to the test method herein reported, lower than 36 Kg/cm² both in the longitudinal and transverse directions and/or higher than 25 Kg/cm²; and/or
a free shrink in the longitudinal direction, measured at 85° C. in water according to ASTM D 2732, higher than 5%; and/or
a free shrink in the transverse direction, measured at 85° C. in water according to ASTM D 2732, higher than 3%, and/or lower than 10%; and/or
a difference between the free shrink values in the longitudinal direction and transverse directions, measured at 85° C. in water according to ASTM D 2732, lower than 10%; and/or
an elastic modulus, measured according to ASTM D 882, in the range 8000 to 14000 kg/cm² in each of the longitudinal and transverse directions; and/or
an elongation at break, measured according to ASTM D 882, in the range 70 to 160% in each of the longitudinal and transverse directions; and/or
a tensile at break, measured according to ASTM D 882, in the range 700 to 1200 kg/cm² in each of the longitudinal and transverse directions; and/or
a curling, measured according to the test method herein reported, not higher than 10%, in each one of the longitudinal and transverse directions,
wherein said film is obtainable according to the process of claim 17.

15. A process for manufacturing the films according to claim 1 comprising the steps of:
a) coextruding the resins and/or blends of resins of the various layers through a round or flat extrusion die, thus obtaining a tube or sheet;
b) quenching the tube or sheet at temperature comprised between 5 and 25° C.;
c) cross-linking the tube or sheet;
d) heating the tube or sheet at an orientation temperature comprised between 85° C. and 160° C.;
e) simultaneously or sequentially biaxially stretching the heated tube or sheet at a stretching ratio of at least 2.5:1 and of at most 5:1 in each one of the transverse (TD) and longitudinal (LD) directions;
f) annealing the stretched tube or sheet by heating it at a temperature from 45° C. to 105° C.;
g) cooling the annealed tube or sheet at a temperature lower than 40° C.

16. The manufacturing process according to claim 15 for manufacturing a film for Flowpack packaging applications wherein the annealing step f) is performed at a temperature of at most 80° C.

17. The manufacturing process according to claim 15 for manufacturing a film for Tray Lidding packaging applications wherein the annealing step f) is performed at a temperature higher than 80° C.

18. (canceled)

19. A packaging process, which is a Flowpack packaging process on a horizontal form-fill-seal (HFFS) machine and which comprises:
(a) providing a film according to claim 1,
(b) running the film through a former thus forming a tube,
(c) inserting a product, optionally placed in a container, into the tube,
(d) sealing the tube longitudinally,
(e) sealing and cutting the tube transversally at the beginning and at the end of the package, optionally gas-flushing the tube before closing it, and
(f) heat-shrinking the package.

20. (canceled)

21. A packaging process which is a tray lidding packaging process and which comprises:
(I) providing a tray with a heat-sealable rim,
(II) loading said tray with the product to be packaged,
(III) applying a lid on top of said tray,
(IV) heat-sealing said lid to the tray rim, optionally modifying the atmosphere between said lid and said tray, thus providing a package, and
(V) heat shrinking the package, simultaneously or subsequently to the sealing step, in which the lid is a film according to of claim 1.

22. (canceled)

23. (canceled)

24. (canceled)

25. The use of the film according to claim 1 in a tray lidding packaging process, where the film is used in combination with an innermost gas-permeable packaging film, or in the manufacture of shrinkable flexible containers.

26. The film according to claim 5 wherein the sealant layer (B) is selected from ethylene homopolymers, ethylene co-polymers, propylene homopolymers, propylene co-polymers and blends thereof.
